(19) United States
(12) Patent Application Publication
(10) Pub. No.: US 2016/0319192 A1
(43) Pub. Date: Nov. 3, 2016

(54) NEMATIC LIQUID CRYSTAL COMPOSITION AND LIQUID CRYSTAL DISPLAY ELEMENT INCLUDING THE SAME

(71) Applicant: DIC CORPORATION, Tokyo (JP)

(72) Inventors: Shinichi Hirata, Kita-adachi-gun (JP); Tomoaki Hara, Kita-adachi-gun (JP); Naomi Hatano, Kita-adachi-gun (JP); Yasuo Umezu, Kita-adachi-gun (JP)

(73) Assignee: DIC Corporation, Tokyo (JP)

(21) Appl. No.: 15/108,859

(22) PCT Filed: Dec. 17, 2014
(86) PCT No.: PCT/JP2014/083448

§ 371 Date: Jun. 29, 2016

(30) Foreign Application Priority Data
Jan. 6, 2014 (JP) 2014-000247

(51) Int. Cl. C09K 19/32; G02F 1/1335; C09K 19/38; G02F 1/1343; C09K 19/30; C09K 19/56

(52) U.S. Cl. CPC C09K 19/322; C09K 19/3066; C09K 19/3003; C09K 19/56; C09K 19/3809; G02F 1/13439; G02F 1/133528; C09K 2019/3004; C09K 2019/3009; C09K 2019/301; C09K 2019/3016; C09K 2019/0466

(57) ABSTRACT

There is provided a liquid crystal composition whose refractive index anisotropy (Δn) and nematic phase-isotropic liquid phase transition temperature (Tₙᵢ) are sufficiently high, whose viscosity (η) is sufficiently low, whose rotational viscosity (γ₁) is sufficiently low, whose elastic constant (K₃₃) is high, whose dielectric anisotropy (Δ∈) is high or whose Δ∈ is negative with a large absolute value, and whose decrease in reliability after UV irradiation is small, and also provide a liquid crystal display element including the same, which has the excellent display quality and the high response speed. It has been found that the above object can be achieved by forming a polymerizable compound containing liquid crystal composition, which includes a polymerizable compound with a particular chemical structure and a non-polymerizable liquid crystal compound, the polymerizable compound with a particular chemical structure being contained at a particular ratio, and a liquid crystal display element including the same.

### TECHNICAL FIELD

The present invention relates to a nematic liquid crystal composition with high reliability, which is useful as a liquid crystal display material, and a liquid crystal display element including the same.

### BACKGROUND ART

Liquid crystal display elements have been used for clocks, calculators, and moreover home-use electric appliances, measurement equipment, panels for automobiles, word processors, electronic organizers, printers, computers, TV sets, and the like.

Such liquid crystal display elements include, for example, TN (twisted nematic) mode, STN (super twisted nematic) mode, DS (dynamic scattering) mode, GH (guest/host) mode, IPS (in-plane switching) mode, OCB (optically compensated bend) mode, ECB (electrically controlled birefringence) mode, VA (vertically alignment) mode, CSH (color super homeotropic) mode, and FLC (ferroelectric liquid crystal) mode display elements. Driving methods for the same include static driving, multiplex driving, simple-matrix driving method, and an active matrix (AM) method using TFTs (thin film transistors) or TFDs (thin film diodes) in driving.

One of the characteristics required commonly in these display methods is the high reliability. Since the liquid crystal display element is exposed to UV light in the manufacture or during the use, it is important that the UV irradiation does not result in the deterioration and the like or even if the deterioration has occurred, the display is not affected thereby.

In the examinations for increasing the reliability, the suppression of the deterioration due to the UV irradiation by purifying a liquid crystal composition itself and a compound as one component of the liquid crystal compositions has been considered (Patent Literatures 1 to 6).

Although the reliability has been increased as a result of such examinations, the demand for the current liquid crystal display element has been increasing more and the liquid crystal composition with much higher reliability is desired.

### CITATION LIST

### Patent Literatures

Patent Literature 1: JP-A-2003-24704

Patent Literature 2: JP-A-2008-248248

Patent Literature 3: JP-A-2003-213261

Patent Literature 4: JP-A-2003-335711

Patent Literature 5: JP-A-2003-64364

Patent Literature 6: JP-A-2003-166091

### SUMMARY OF THE INVENTION

### Problems to be Solved by the Invention

An object of the present invention is to provide a liquid crystal composition whose refractive index anisotropy (Δn) and nematic phase-isotropic liquid phase transition temperature (Tₙᵢ) are sufficiently high, whose viscosity (η) is sufficiently low, whose rotational viscosity (γ₁) is sufficiently low, whose elastic constant (K₃₃) is high, whose dielectric anisotropy (Δ∈) is high or whose Δ∈ is negative with a large absolute value, and whose decrease in reliability after UV irradiation is small, and also provide a liquid crystal display element including the same, which has the excellent display quality and the high response speed.

### Solution to the Problems

As a result of concerted studies made by the present inventors, it has been found out that the above object can be achieved by forming a polymerizable compound containing liquid crystal composition, which includes a polymerizable compound with a particular chemical structure and a non-polymerizable liquid crystal compound, the polymerizable compound with a particular chemical structure being contained at a particular ratio, and a liquid crystal display element including the same.

### Effects of the Invention

The polymerizable compound containing liquid crystal composition according to the present invention has the sufficiently high refractive index anisotropy (Δn) and nematic phase-isotropic liquid phase transition temperature (Tₙᵢ), the sufficiently low viscosity (η), the sufficiently low rotational viscosity (γ₁), the high elastic constant (K₃₃), and the high dielectric anisotropy (Δ∈) or the negative Δ∈ with a large absolute value, and the decrease in reliability thereof after UV irradiation is small. Therefore, the liquid crystal display element, which has the excellent display quality and the high response speed, can be provided.

### BRIEF DESCRIPTION OF THE DRAWINGS

FIG. 1 is a diagram illustrating the relation of VHR among MLC-A-1 to 3 (Comparative Examples 1-1 to 3) and MLC-1-1 to 3 (Examples 1-1 to 3) before and after the UV irradiation.

### DESCRIPTION OF THE EMBODIMENT

A polymerizable compound containing liquid crystal composition according to the present invention is a polymerizable compound containing liquid crystal composition containing a polymerizable compound and a liquid crystal compound. As the polymerizable compound, one kind or two or more kinds of compounds represented by the following general formula (1) are contained:

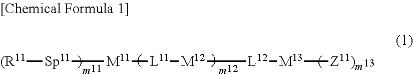

(in the above general formula (1), Z¹¹ represents a fluorine atom, a cyano group, a hydrogen atom, an alkyl group with 1 to 15 carbon atoms whose hydrogen atom may be substituted with a halogen atom, an alkoxy group with 1 to 15 carbon atoms whose hydrogen atom may be substituted with a halogen atom, an alkenyl group with 1 to 15 carbon atoms whose hydrogen atom may be substituted with a halogen atom, an alkenyloxy group with 1 to 15 carbon atoms whose hydrogen atom may be substituted with a halogen atom, or -Sp¹²-R¹²,

R¹¹ and R¹² independently represent any of the following formulae (R-1) to (R-15):

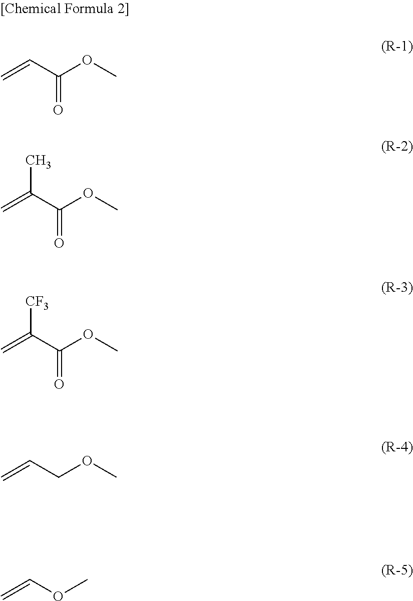

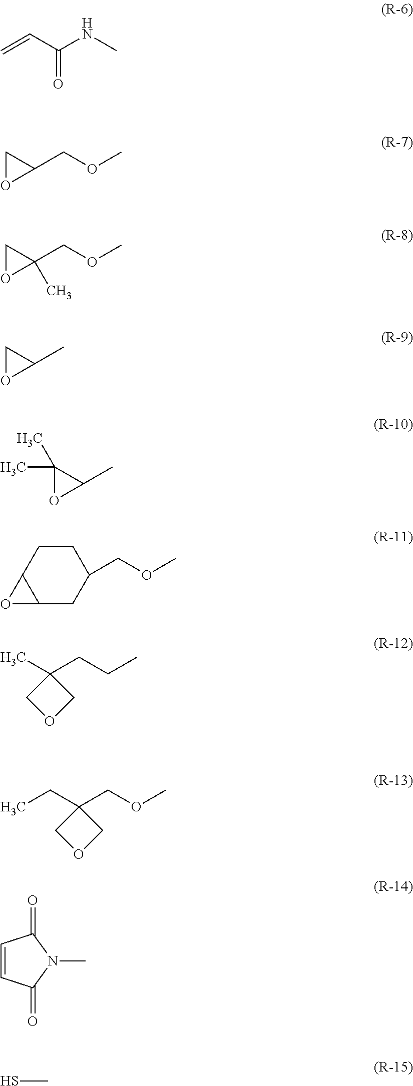

Sp¹¹ and Sp¹² represent a spacer group.

L¹¹ and L¹² independently represent a single bond, —O—, —S—, —CH₂—, —OCH₂—, —CH₂O—, —CO—, —C₂H₄—, —COO—, —OCO—, —OCOOCH₂—, —CH₂OCOO—, —OCH₂CH₂O—, —CO—NR^{a}—, —NR^{a}—CO—, —SCH₂—, —CH₂S—, —CH═CR^{a}—COO—, —CH═CR^{a}—OCO—, —COO—CR^{a}═CH—, —OCO—CR^{a}═CH—, —COO—CR^{a}═CH—COO—, —COO—CR^{a}═CH—OCO—, —OCO—CR^{a}═CH—COO—, —OCO—CR^{a}═CH—OCO—, —(CH₂)_{z}—C(═O)—O—, —(CH₂)z-O—(C═O)—, —O—(C═O)—(CH₂)z-, —(C═O)—O—(CH₂)z-, —CH═CH—, —CF═CF—, —CF═CH—, —CH═CF—, —CF₂—, —CF₂O—, —OCF₂—, —CF₂CH₂—, —CH₂CF₂—, —CF₂CF₂—, or —C≡C— (in the formula, R^{a} independently represents a hydrogen atom or an alkyl group with 1 to 4 carbon atoms, and in the formula, z represents an integer of 1 to 4),

M¹² represents a 1,4-phenylene group, a 1,4-cyclohexylene group, an anthracene-2,6-diyl group, a phenanthrene-2,7-diyl group, a pyridine-2,5-diyl group, a pyrimidine-2,5-diyl group, a naphthalene-2,6-diyl group, an indane-2,5-diyl group, a 1,2,3,4-tetrahydronaphthalene-2,6-diyl group, or a 1,3-dioxane-2,5-diyl group, and M¹² may be non-substituted or be substituted with an alkyl group with 1 to 12 carbon atoms, a halogenated alkyl group with 1 to 12 carbon atoms, an alkoxy group with 1 to 12 carbon atoms, a halogenated alkoxy group with 1 to 12 carbon atoms, a halogen atom, a cyano group, a nitro group, or —R¹¹,

M¹¹ represents any of the following formulae (i-11) to (ix-11):

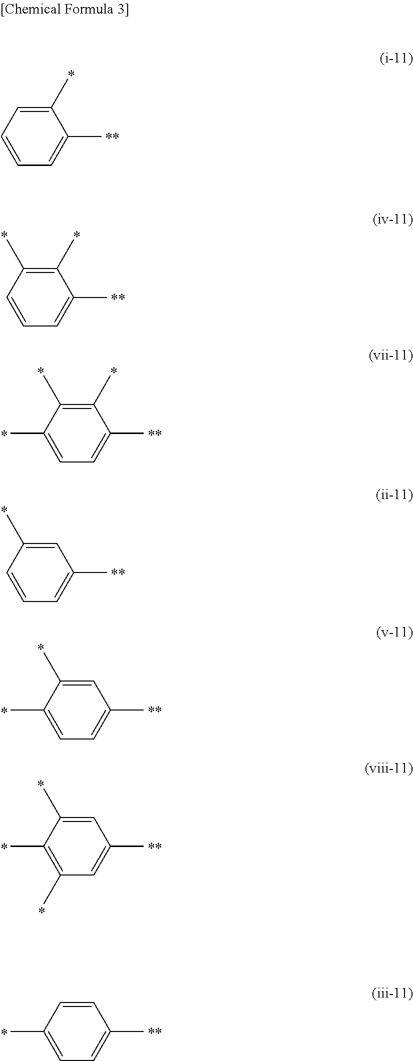

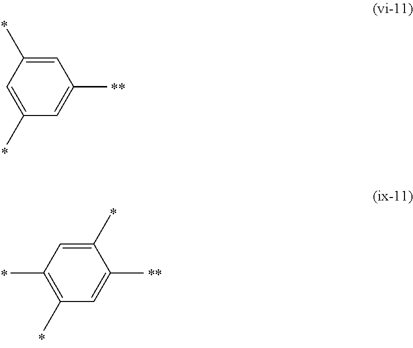

(in the formula, the compound is bonded to Sp¹¹ at ★, and to L¹¹ or L¹² at ★★).

M¹³ represents any of the following formulae (i-13) to (ix-13):

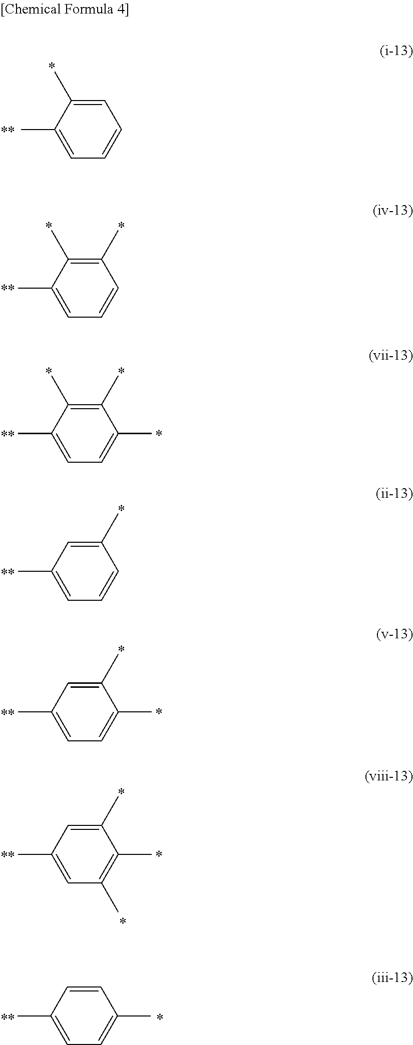

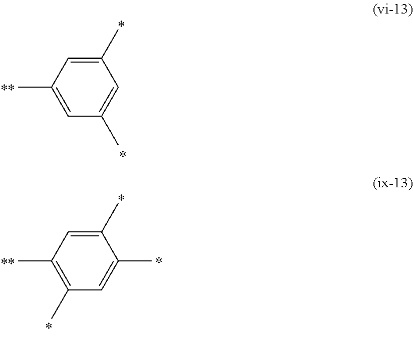

(in the formula, the compound is bonded to Z¹¹ at ★ and to L² at ★★),

m¹² represents 0, 1, 2, or 3, m¹¹ and m¹³ independently represent 1, 2, or 3, and when there is a plurality of Z¹¹, the plurality of Z¹¹ is either the same or different, when there is a plurality of R¹¹, the plurality of R¹¹ is either the same or different, when there is a plurality of R¹², the plurality of R¹² is either the same or different, when there is a plurality of Sp¹¹, the plurality of Sp¹¹ is either the same or different, when there is a plurality of Sp¹², the plurality of Sp¹² is either the same or different, when there is a plurality of L¹¹, the plurality of L¹¹ is either the same or different, and when there is a plurality of M¹², the plurality of M¹² is either the same or different);

as the liquid crystal compound, one kind or two or more kinds of compounds represented by a general formula (LC) are contained:

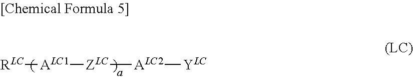

(in the general formula (LC), R^{LC} represents an alkyl group with 1 to 15 carbon atoms, one or two or more CH₂ groups in the alkyl group may be substituted with —O—, —CH═CH—, —CO—, —OCO—, —COO—, or —C≡C— so that the oxygen atom is not adjacent directly, and one or two or more hydrogen atoms in the alkyl group may be substituted with a halogen atom arbitrarily,

A^{LC1} and A^{LC2} independently represent a group selected from:

(a) a trans-1,4-cyclohexylene group (one CH₂ group or two or more non-adjacent CH₂ groups in this trans-1,4-cyclohexylene group may be substituted with an oxygen atom or a sulfur atom);
(b) a 1,4-phenylene group (one CH group or two or more non-adjacent CH groups in this 1,4-phenylene group may be substituted with a nitrogen atom); and
(c) a 1,4-bicyclo(2.2.2)octylene group, a naphthalene-2,6-diyl group, a decahydronaphthalene-2,6-diyl group, a 1,2,3,4-tetrahydronaphthalene-2,6-diyl group, and a chroman-2,6-diyl group, and one or two or more hydrogen atoms included in the group (a), the group (b), and the group (c) may be substituted with F, Cl, CF₃, or OCF₃,

Z^{LC} represents a single bond, —CH═CH—, —CF═CF—, —C≡C—, —CH₂CH₂—, —(CH₂)₄—, —OCH₂—, —CH₂O—, —OCF₂—, —CF₂O—, —COO—, or —OCO—,

Y^{LC} represents a hydrogen atom, a fluorine atom, a chlorine atom, a cyano group, or an alkyl group with 1 to 15 carbon atoms, and one or two or more CH₂ groups in the alkyl group may be substituted with —O—, —CH═CH—, —CO—, —OCO—, —COO—, —C≡C—, —CF₂O—, or —OCF₂— so that an oxygen atom is not directly adjacent, and one or two or more hydrogen atoms in the alkyl group may be substituted with a halogen atom arbitrarily, and

“a” represents an integer of 1 to 4, and when “a” represents 2, 3, or 4 and there is a plurality of A^{LC1}, the plurality of A^{LC1} is either the same or different, and when there is a plurality of Z^{LC}, the plurality of Z^{LC} is either the same or different); and

the polymerizable compound is contained in the polymerizable compound containing liquid crystal composition by 0.41 mass %/o or more and 10.0 mass % or less in total.

In the general formula (1) according to the present invention, it is preferable that Z¹¹ is -Sp¹²-R¹² and R¹¹ and R¹² independently represent any of the formulae (R-1) to (R-3).

In the general formula (1), m¹¹+m¹³ is preferably 3 or more.

In the general formula (1), it is preferable that: L¹¹ is a single bond, —OCH₂—, —CH₂O—, —CO—, —C₂H₄—, —COO—, —OCO—, —COOC₂H₄—, —OCOC₂H₄—, —C₂H₄OCO—, —C₂H₄COO—, —CH═CH—, —CF₂—, —CF₂O—, —(CH₂)_{z}—C(═O)—O—, —(CH₂)z-O—(C═O)—, —O—(C═O)—(CH₂)z-, —(C═O)—O—(CH₂)z-, —OCF₂—, or —C≡C—; and

L¹² is —OCH₂CH₂O—, —COOC₂H₄—, —OCOC₂H₄—, —(CH₂)_{z}—C(═O)—O—, —(CH₂)z-O—(C═O)—, —O—(C═O)—(CH₂)z-, —(C═O)—O—(CH₂)z-, —C₂H₄OCO—, or —C₂H₄COO—, and z in the formula is an integer of 1 to 4.

In the general formula (1), at least one of L¹¹ and L¹² is preferably at least one kind selected from the group consisting of —(CH₂)_{z}—C(═O)—O—, —(CH₂)z-O—(C═O)—, —O—(C═O)—(CH₂)z-, and —(C═O)—O—(CH₂)z-.

In the general formula (1), m¹² represents 1, 2, or 3, and when m¹² is 1, L¹¹ is a single bond, and when m¹² is 2 or 3, at least one of the plurality of L¹¹ is preferably a single bond.

In the general formula (1), m¹² represents 1, 2, or 3, and when m¹² is 1, M¹² is a 1,4-phenylene group, and when m¹² is 2 or 3, at least M¹² adjacent to M¹² through L¹¹ among the plurality of M¹² is preferably a 1,4-phenylene group.

In addition, in the general formula (1), it is preferable that m¹² represents 1, 2, or 3 and at least one of M¹² is a 1,4-phenylene group substituted with one or two or more fluorine.

A preferred structure of the polymerizable compound of the general formula (1) according to the present invention is described below.

First, a polymerizable compound represented by any of the following formulae (1a-1) to (1a-31) is given as a preferred example.

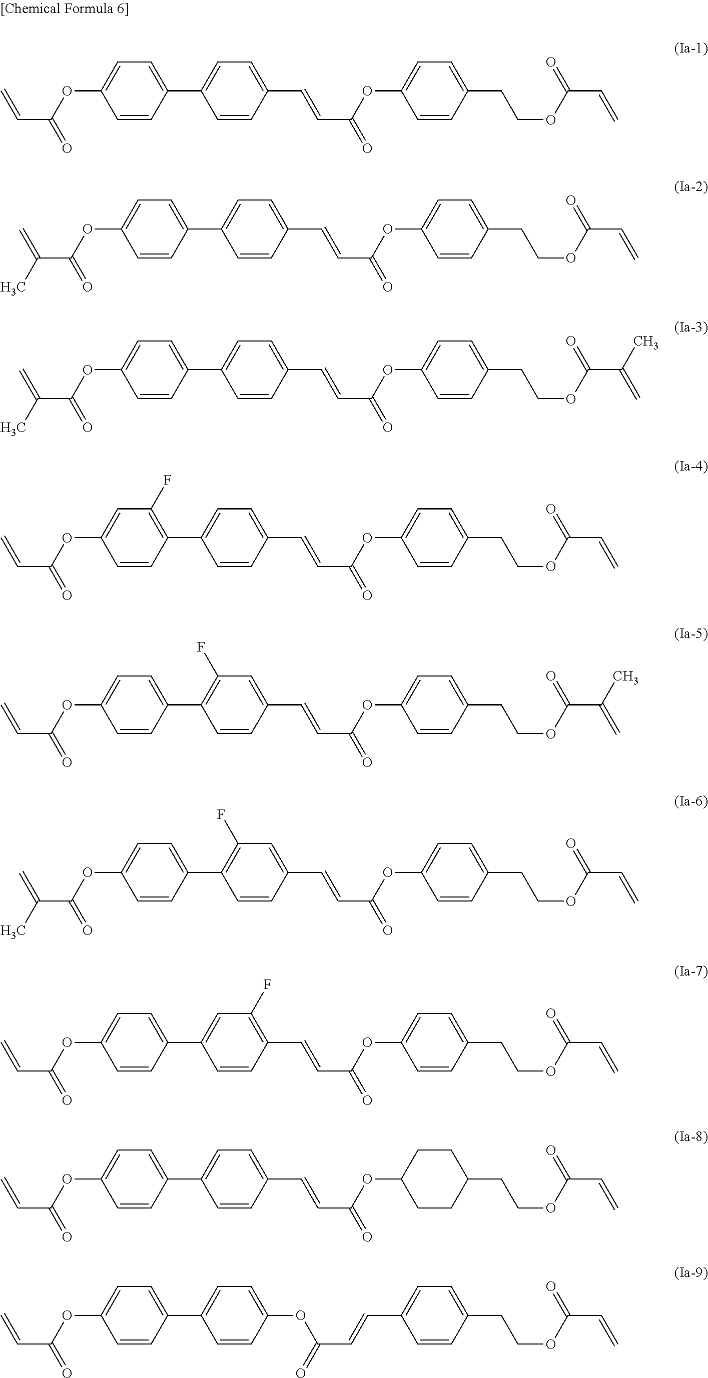

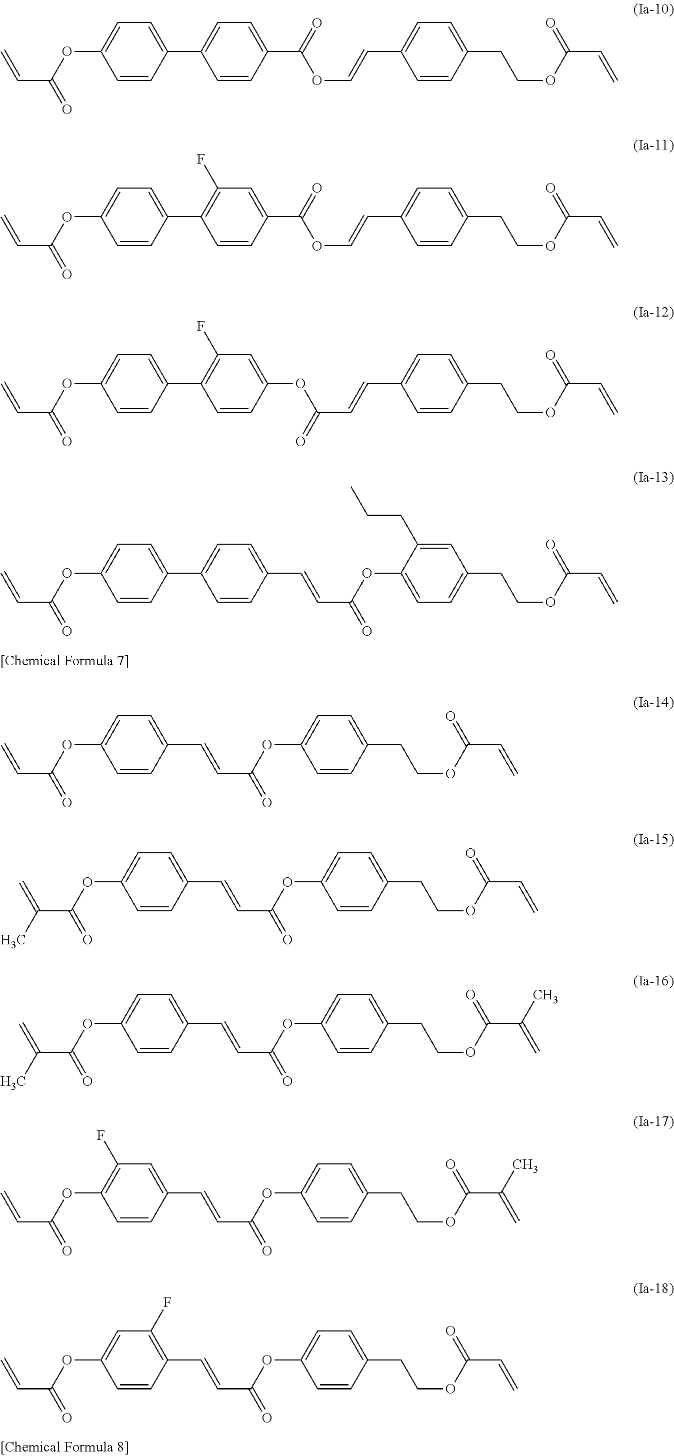

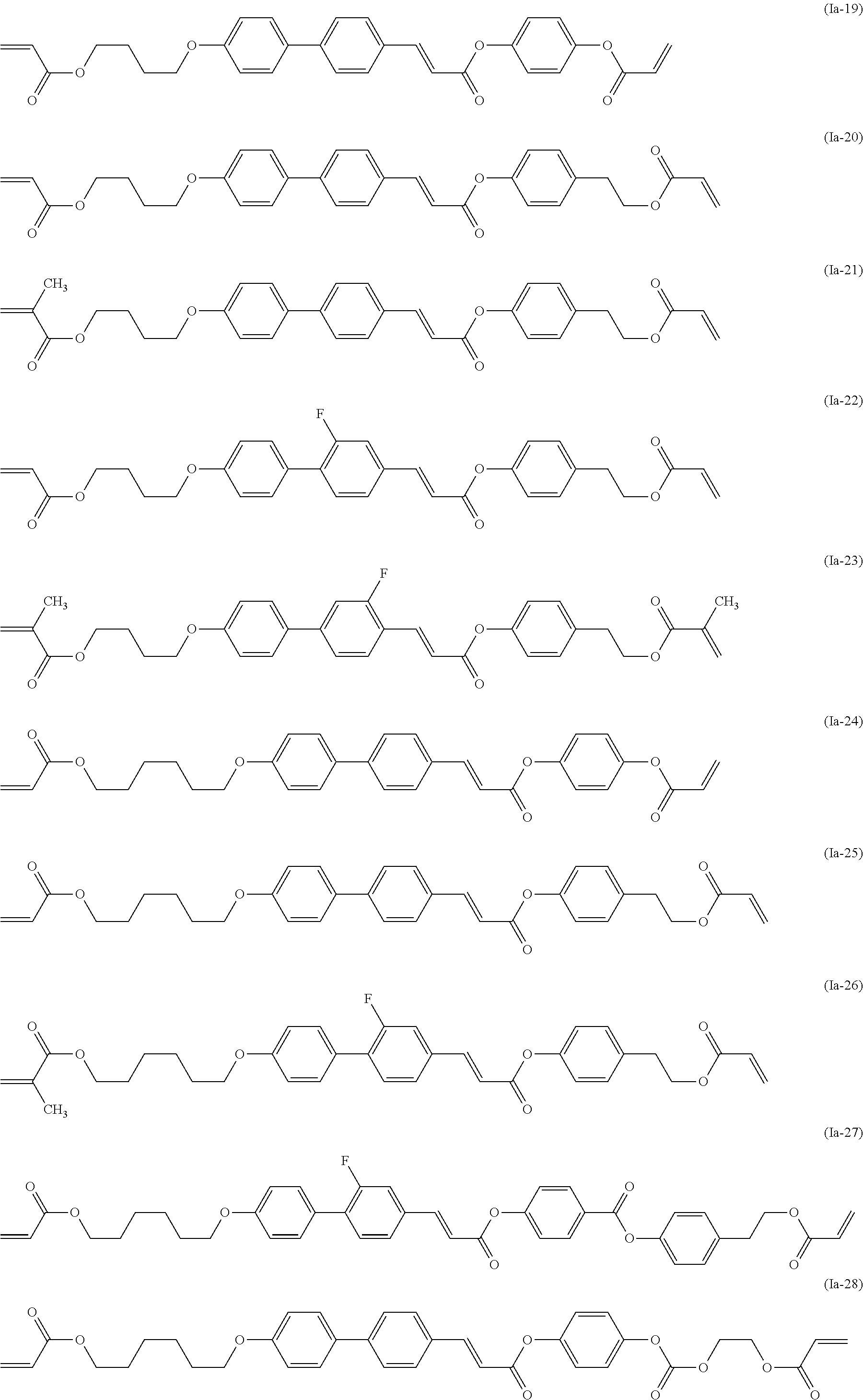

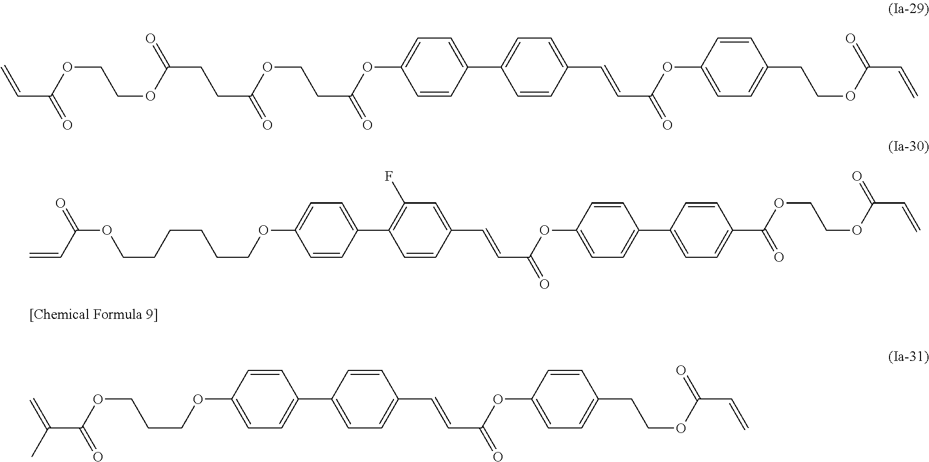

A polymerizable compound represented by any of the following fomulae (1b-1) to (1b-34) is also given as a preferred example.

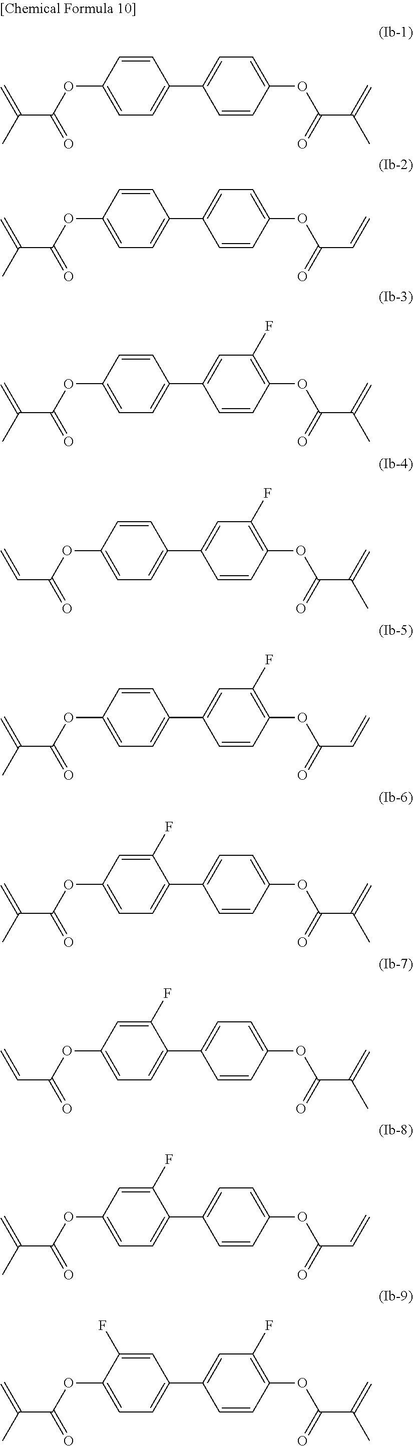

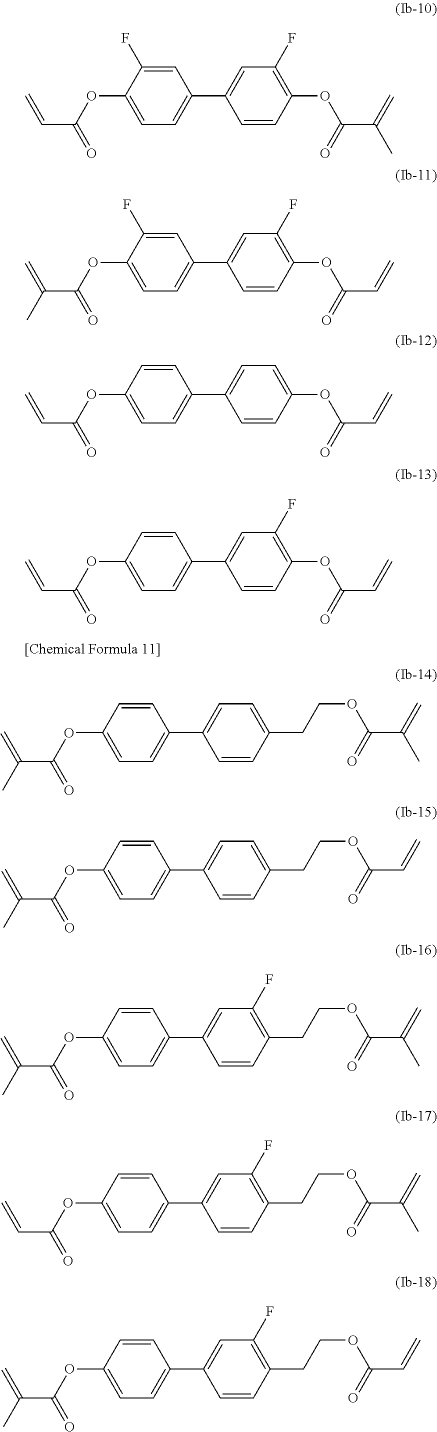

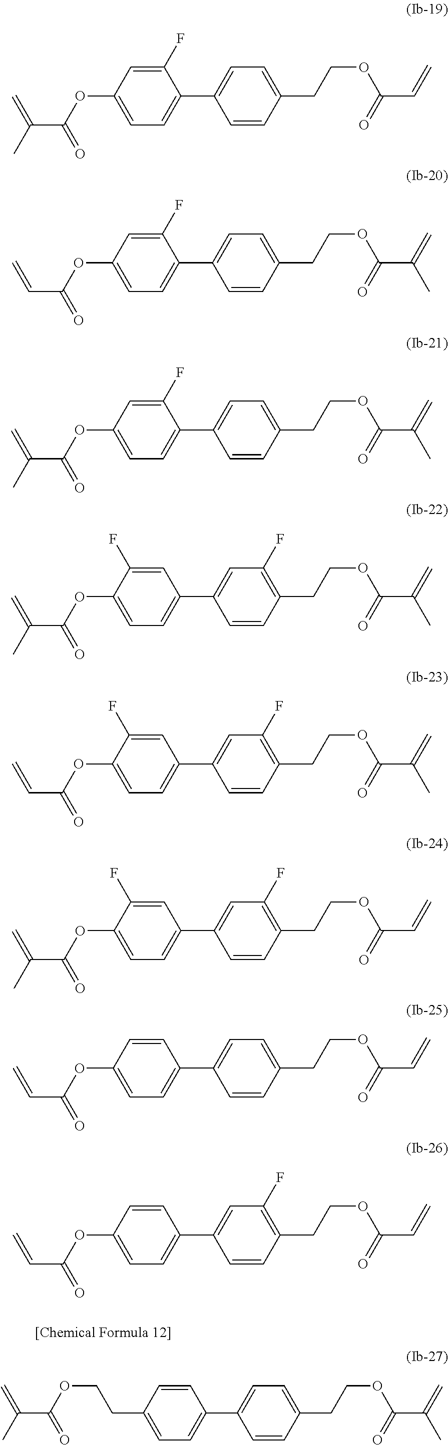

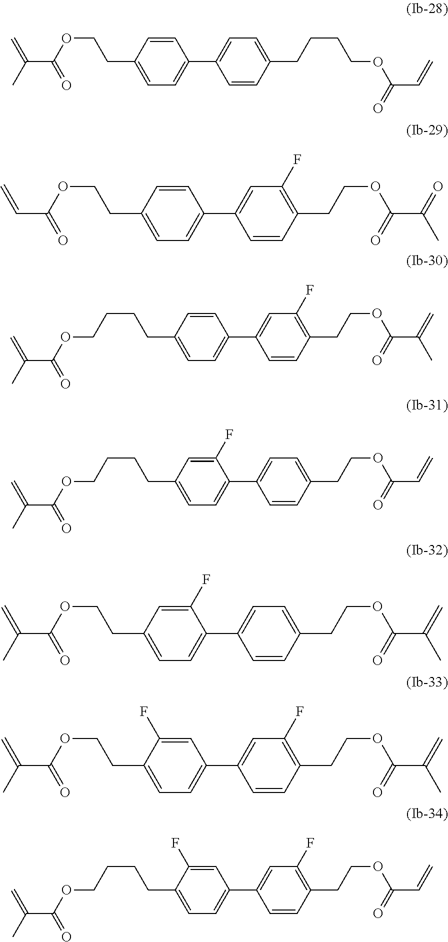

A polymerizable compound represented by any of the following formulae (1c-1) to (1c-52) is also given as a preferred example.

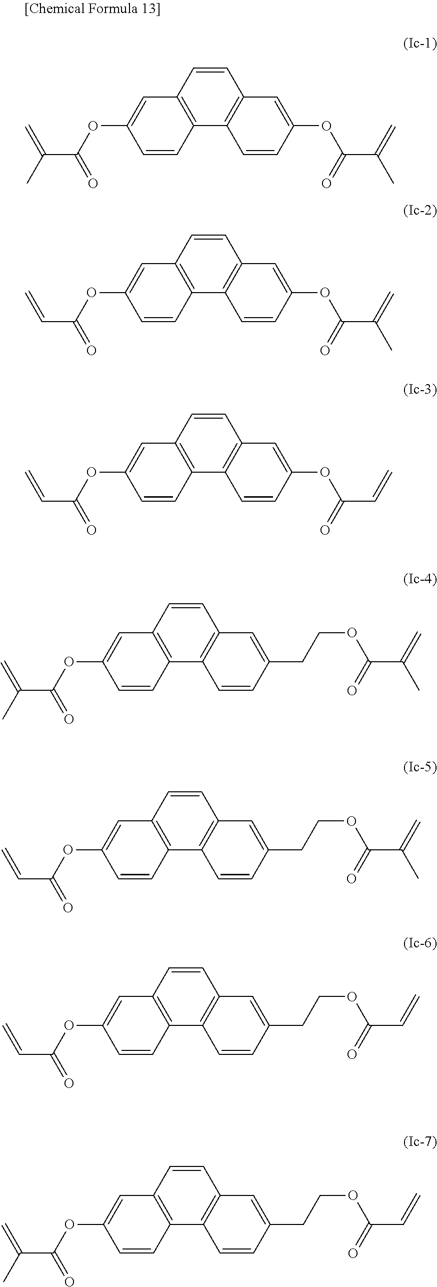

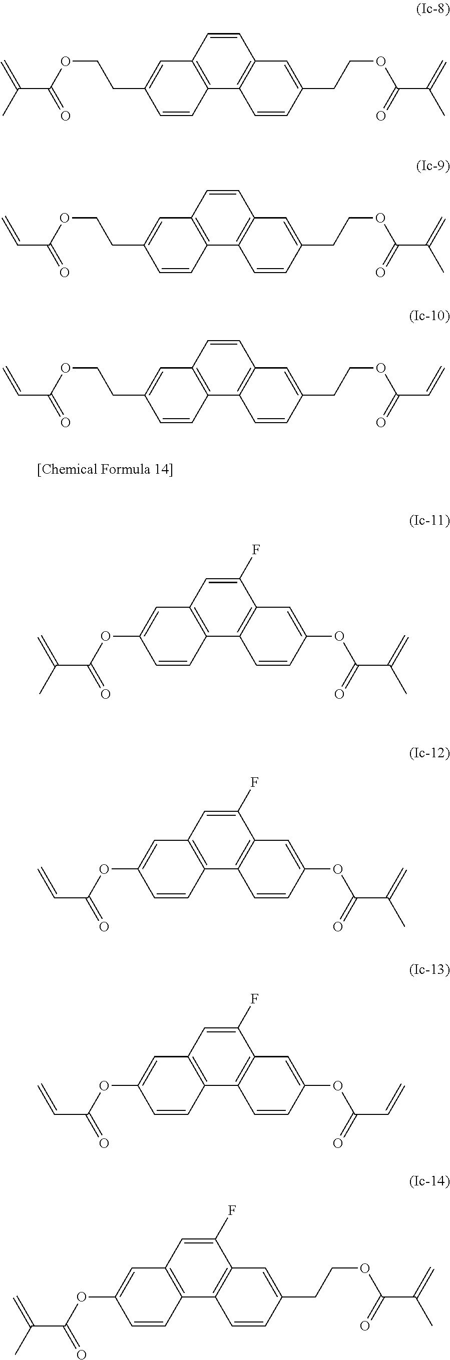

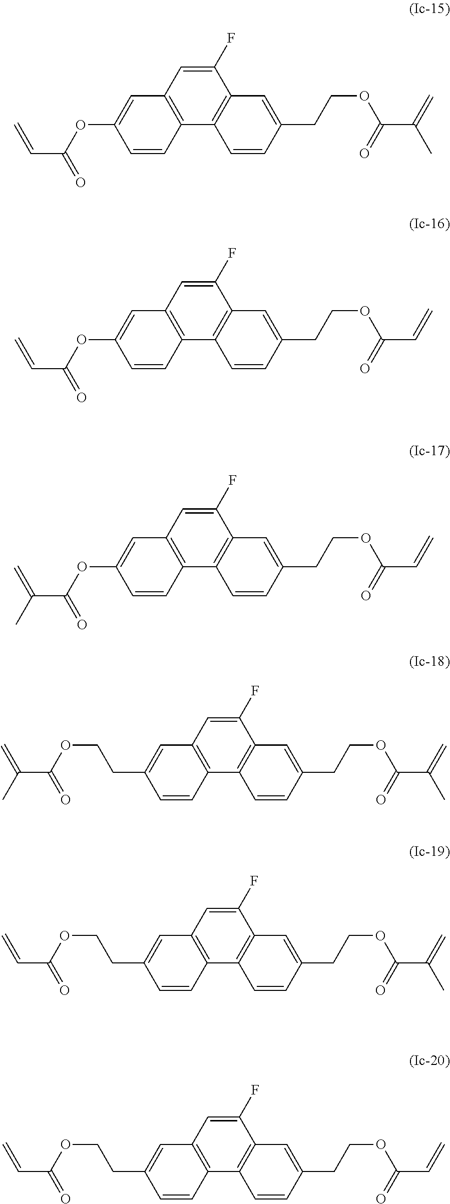

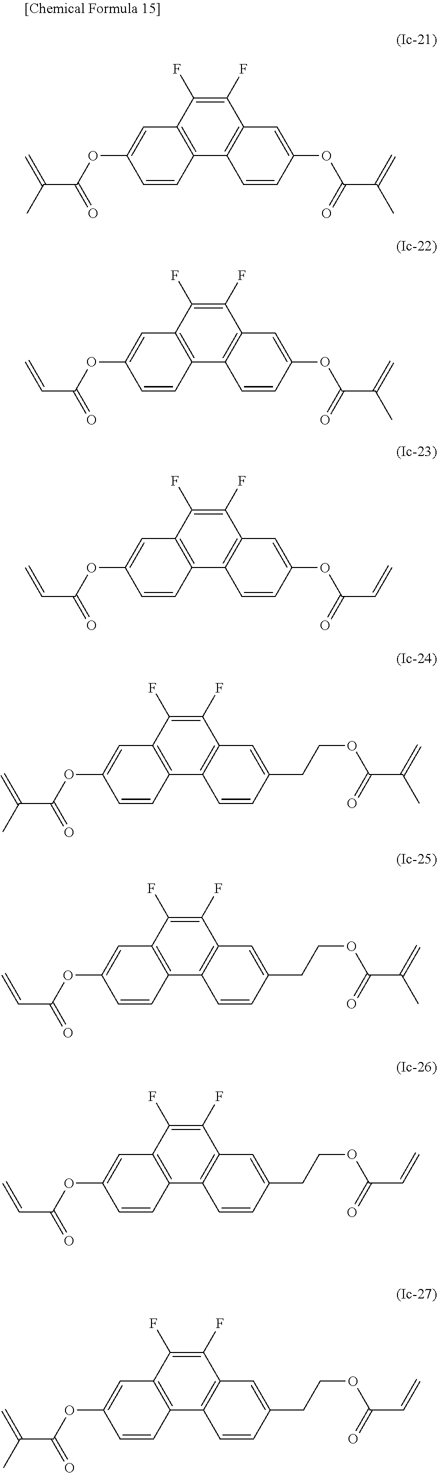

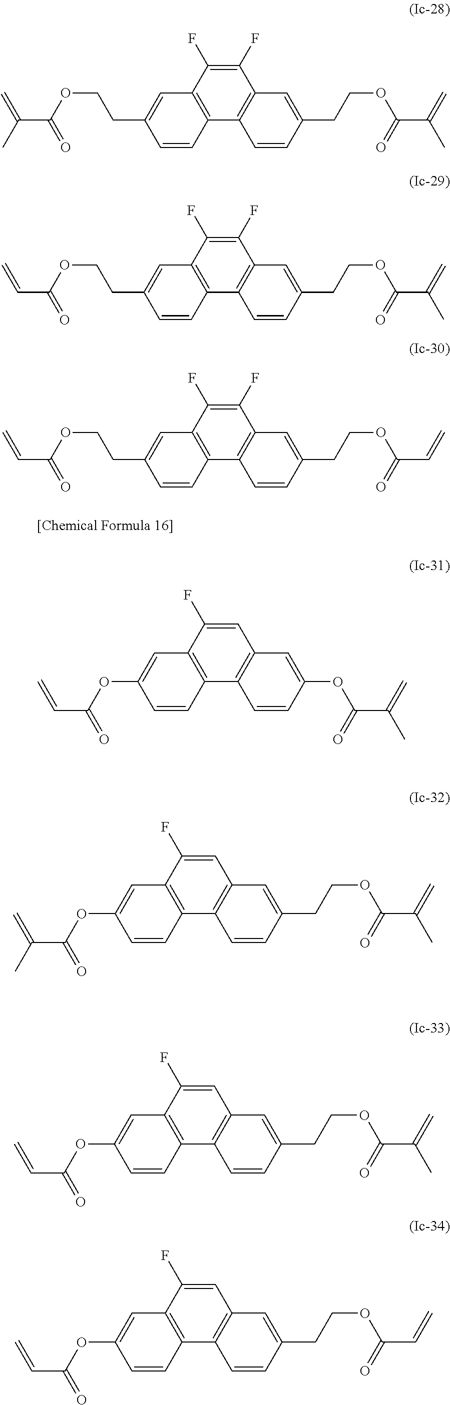

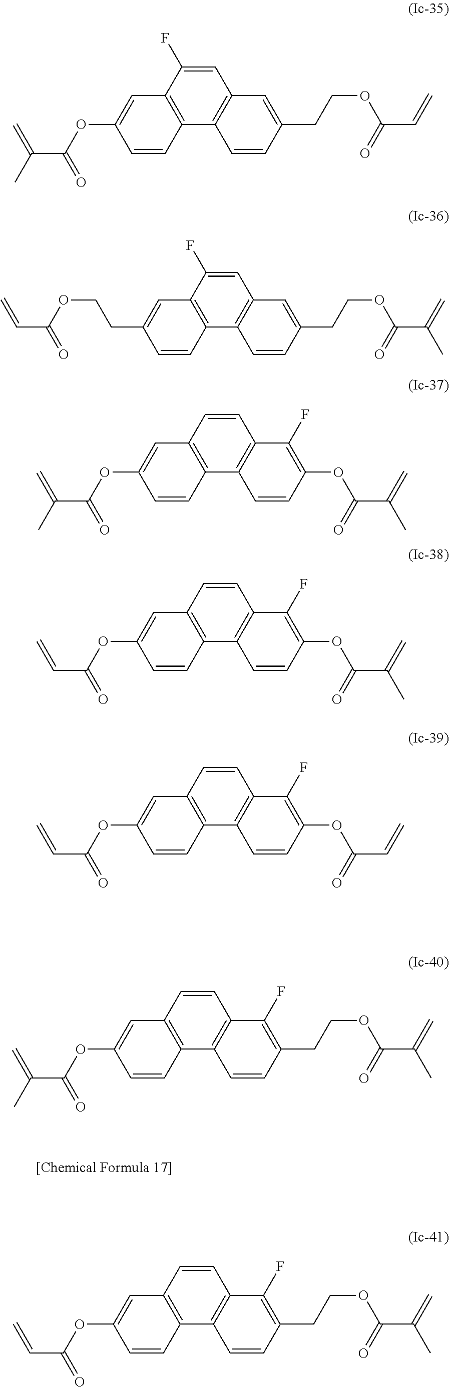

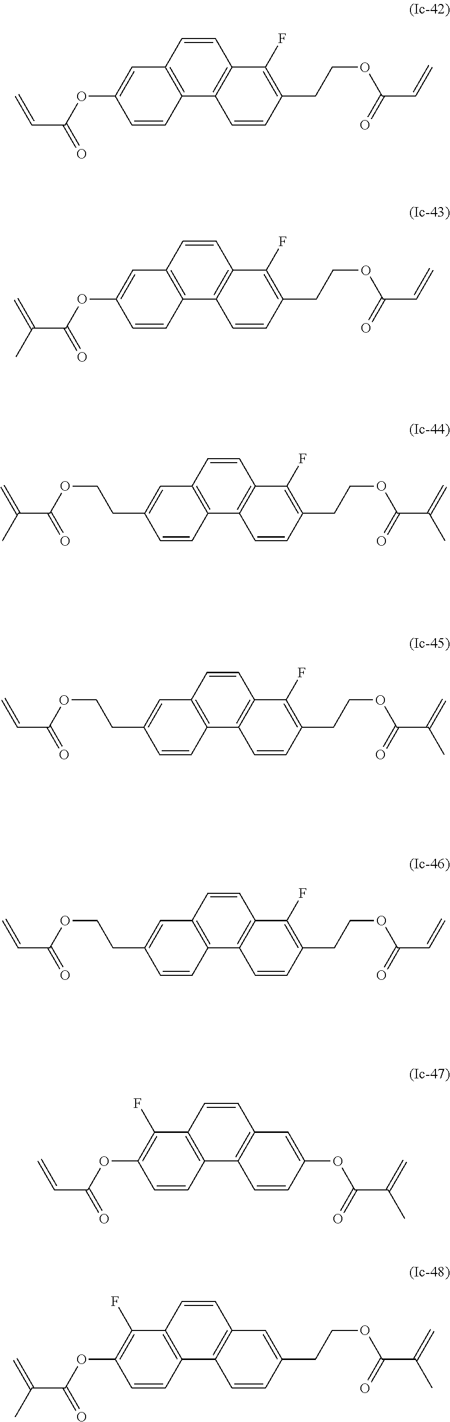

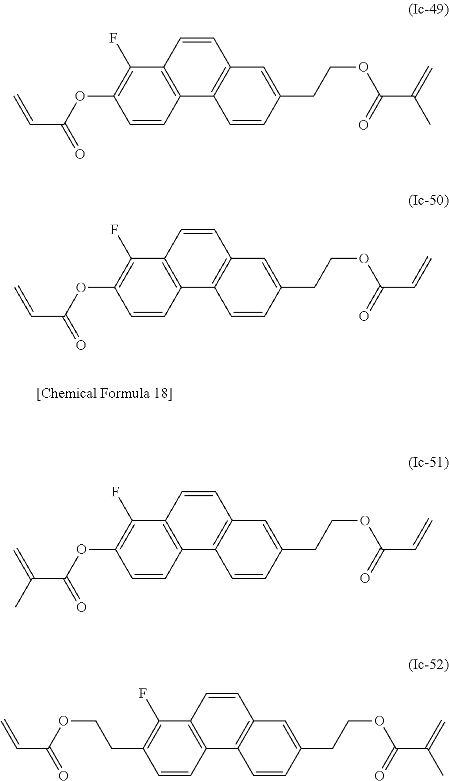

A polymerizable compound represented by any of the following formulae (1d-1) to (1d-36) is also given as a preferred example.

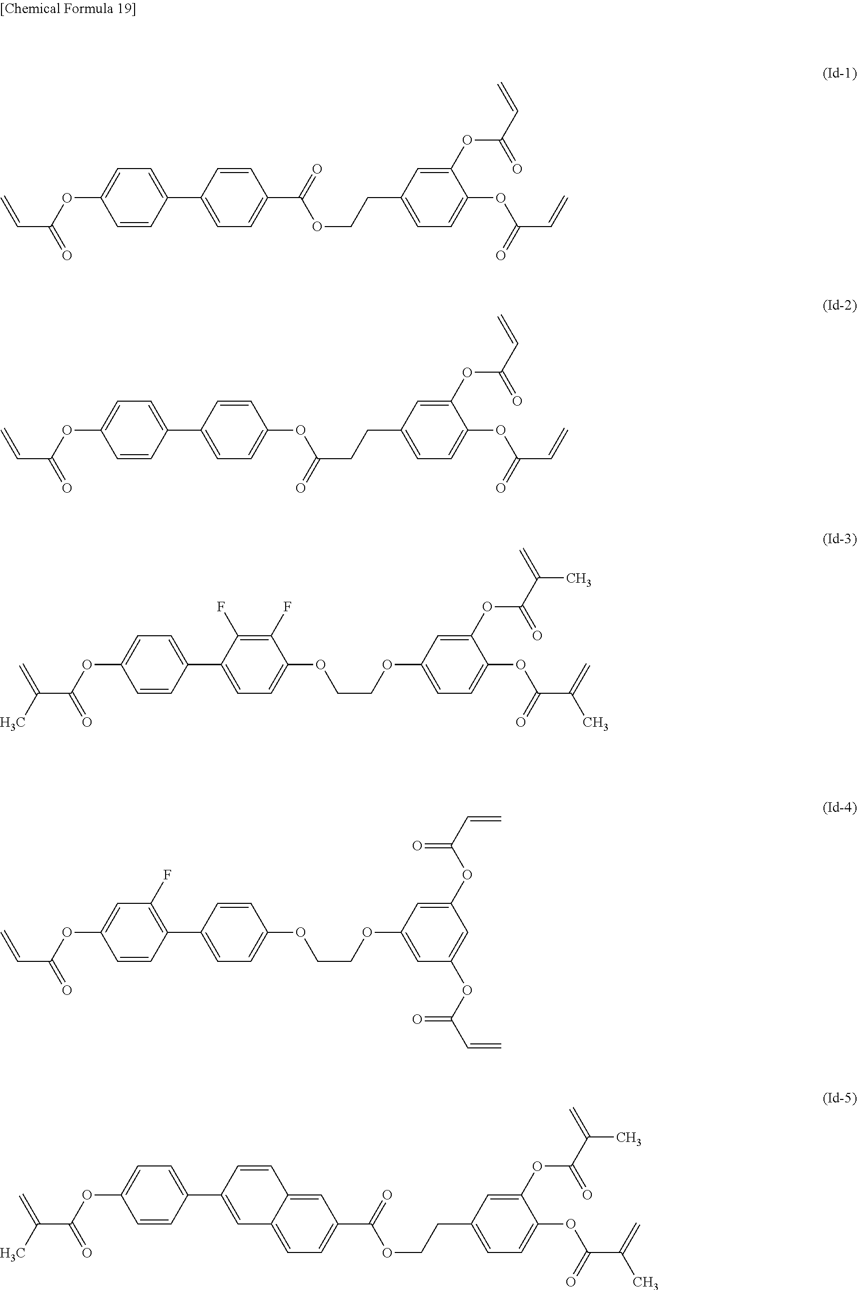

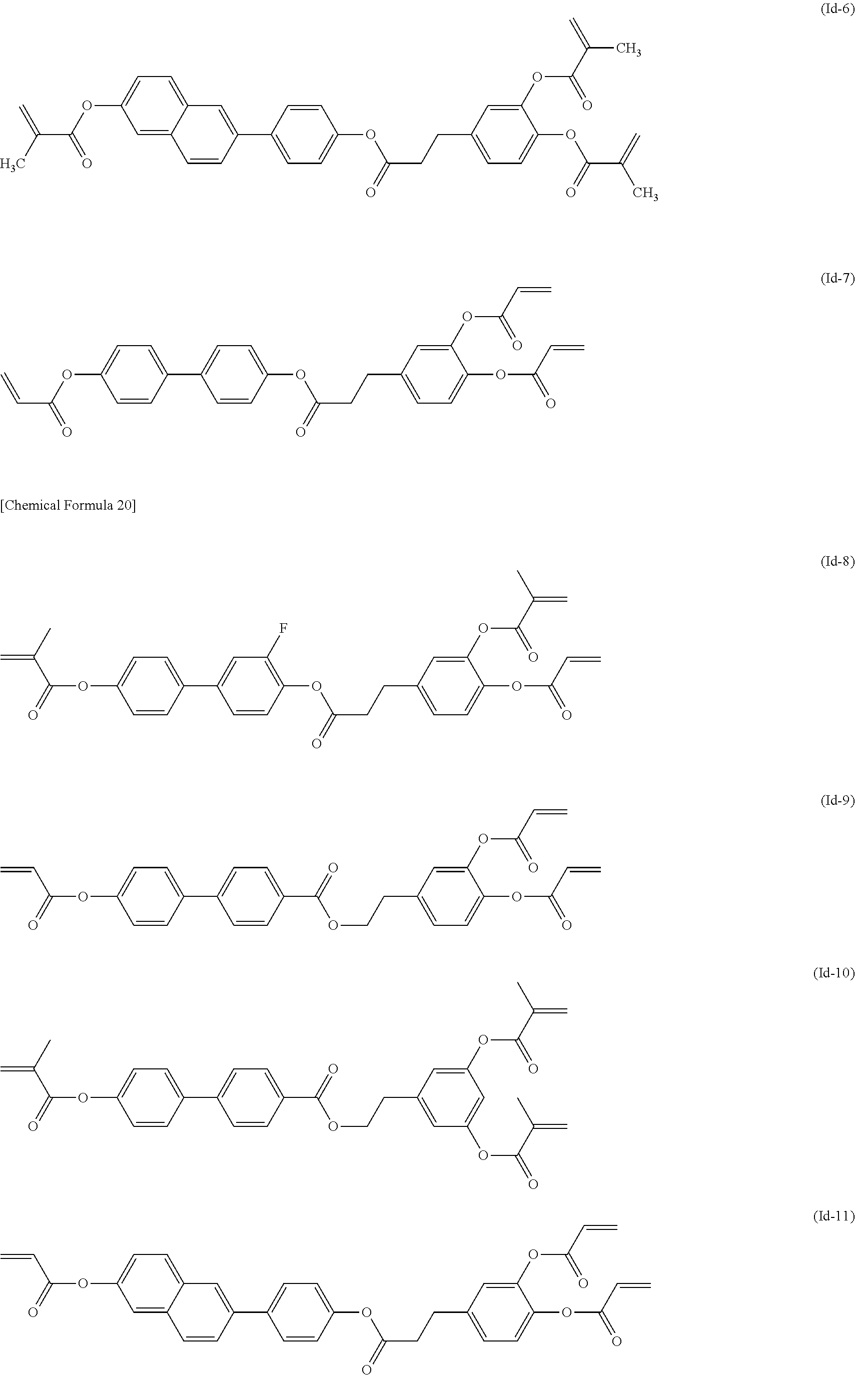

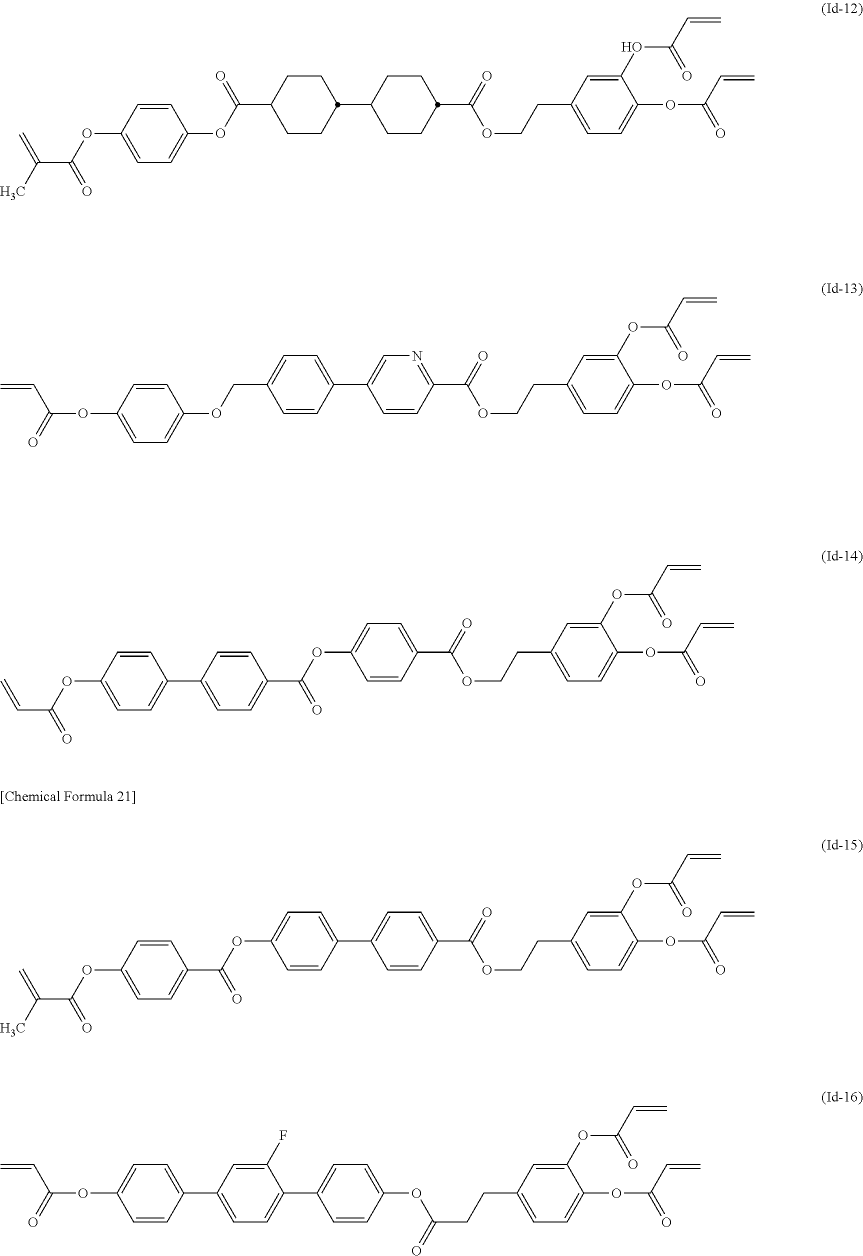

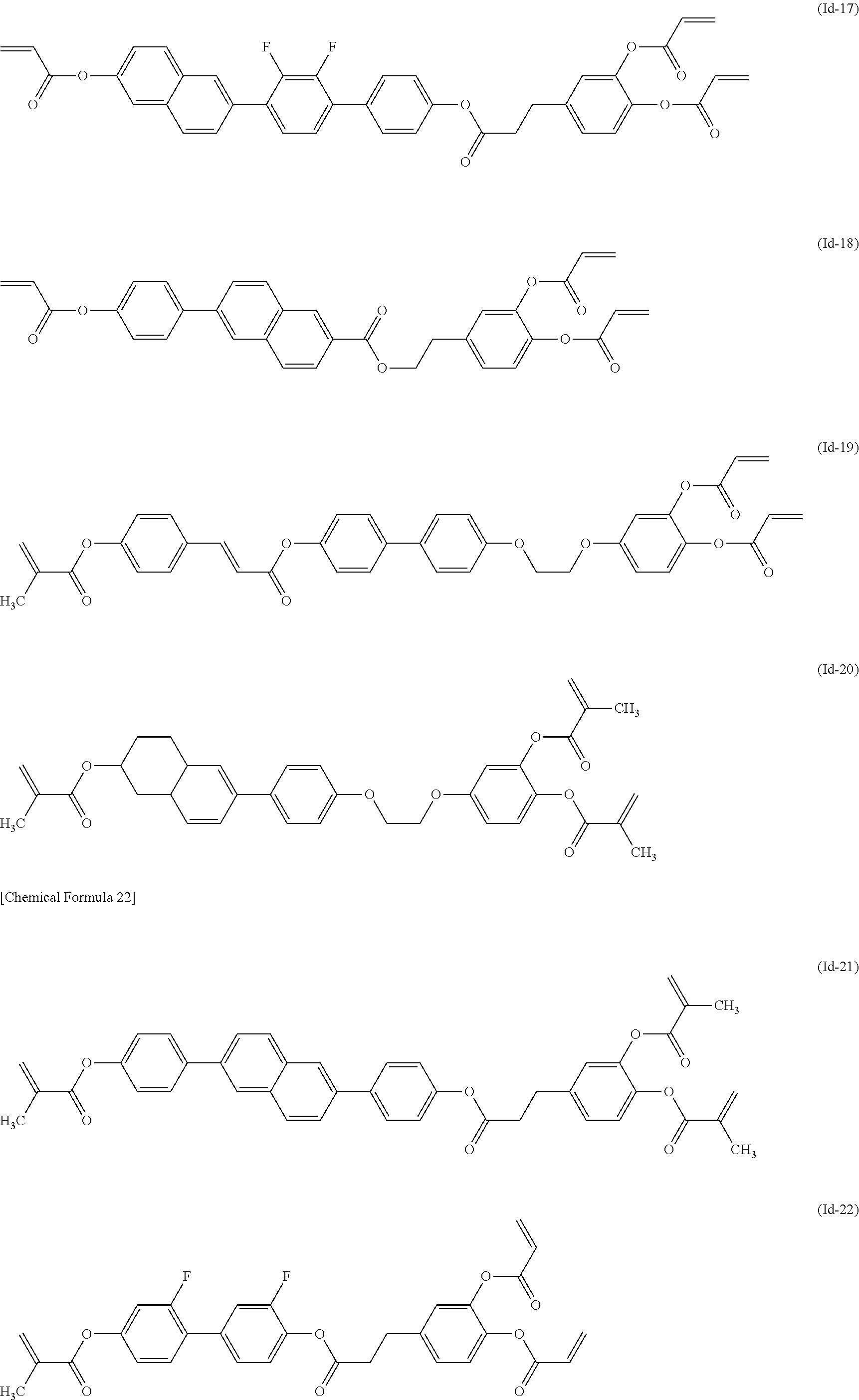

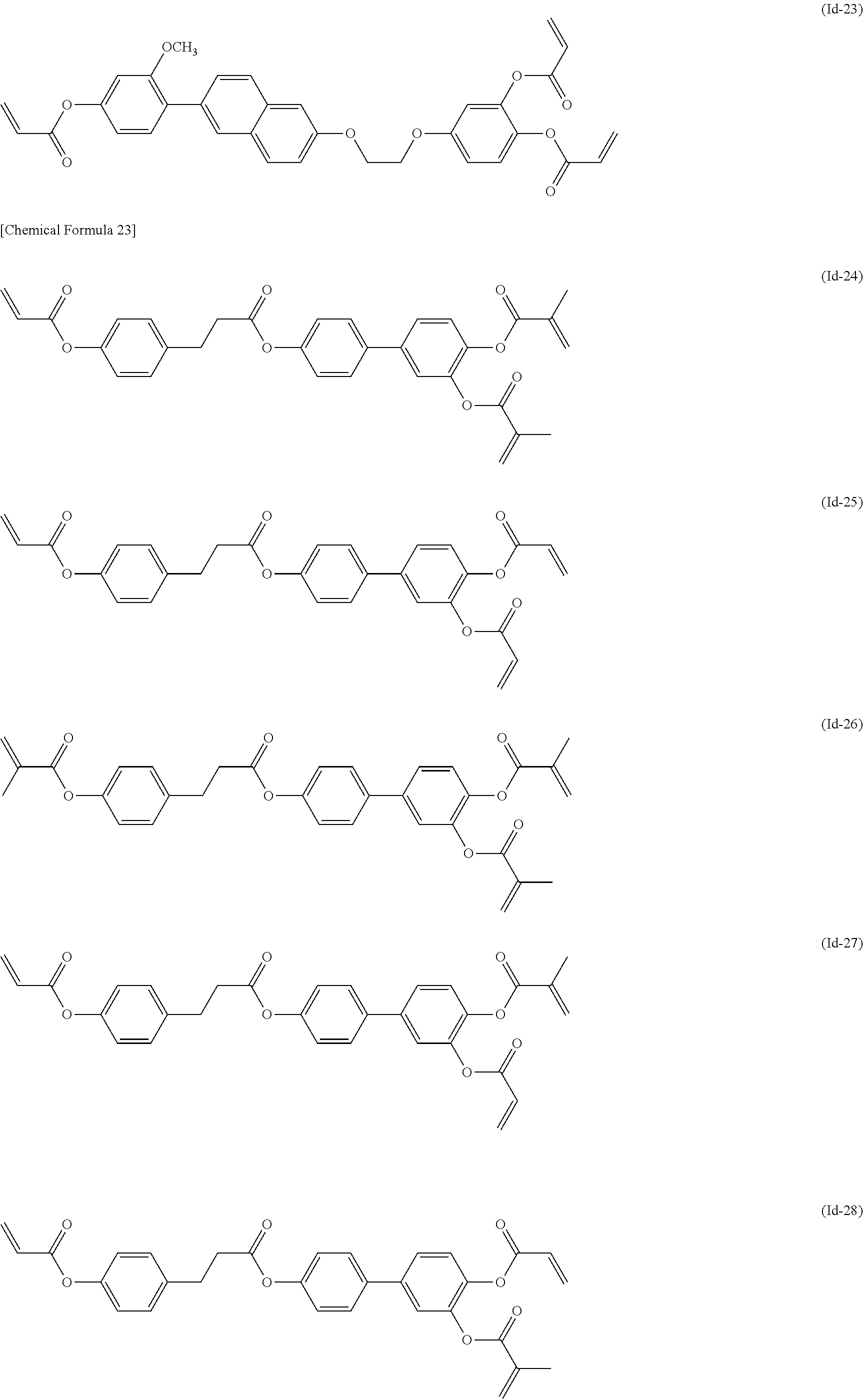

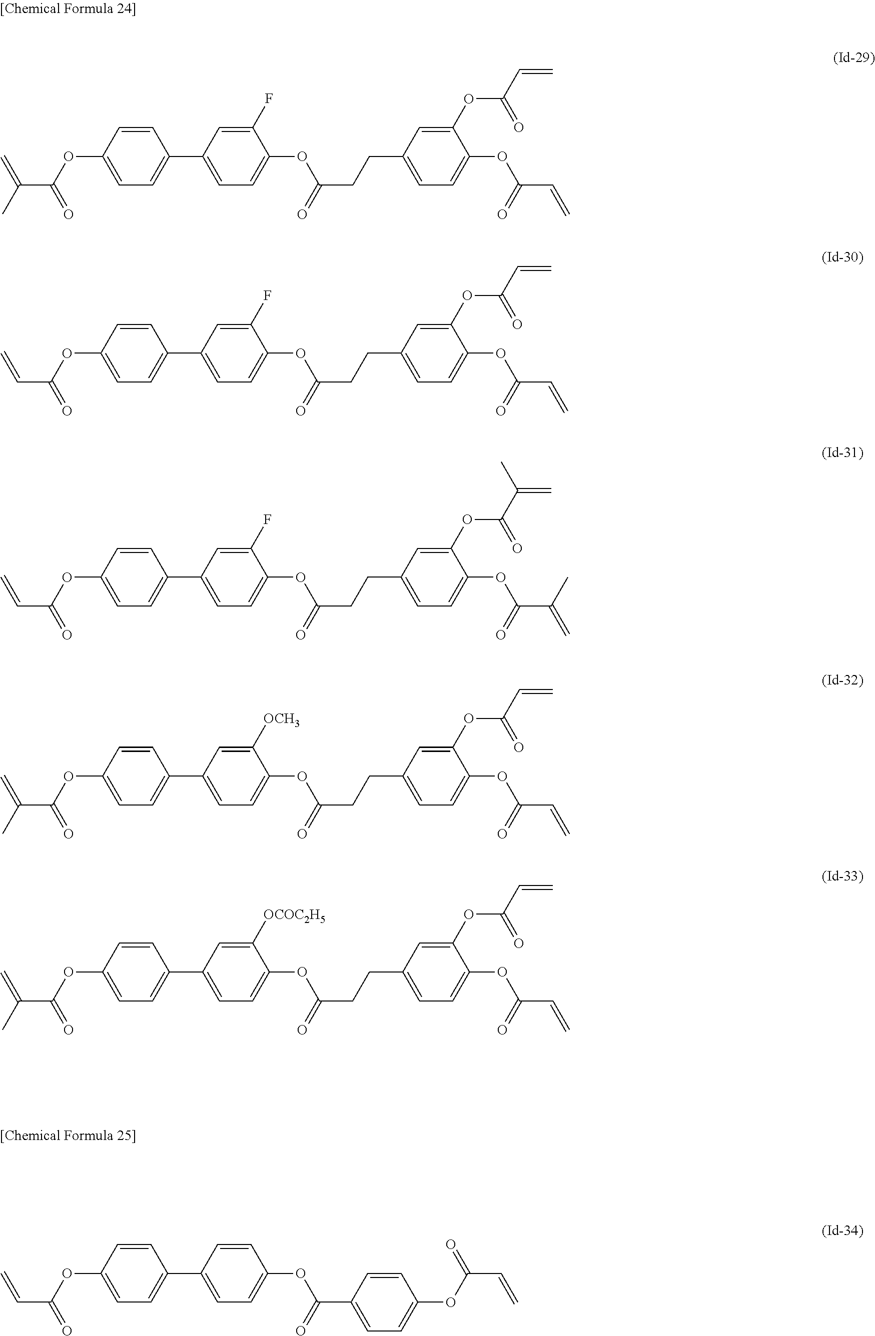

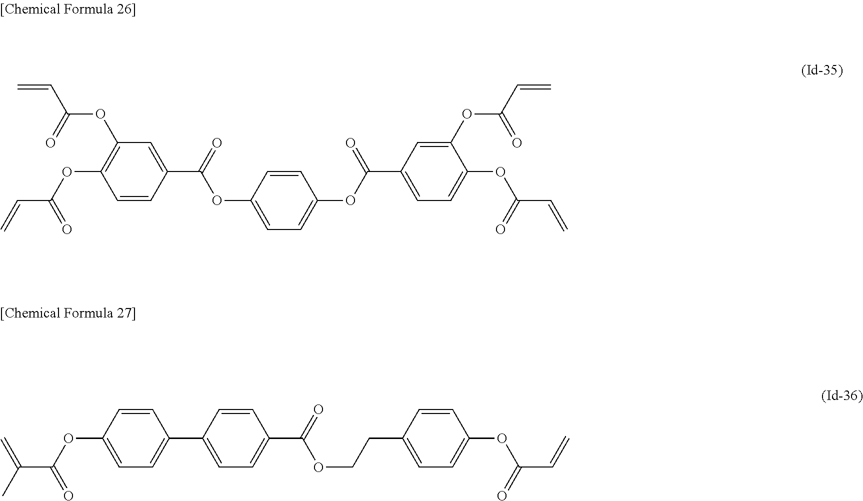

As the liquid crystal compound, the compound represented by the following general formula (LC) is preferably contained:

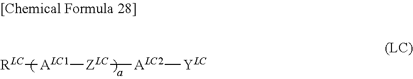

(in the general formula (LC), R^{LC} represents an alkyl group with 1 to 15 carbon atoms, one or two or more CH₂ groups in the alkyl group may be substituted with —O—, —CH═CH—, —CO—, —OCO—, —COO—, or —C≡C— so that an oxygen atom is not directly adjacent, and one or two or more hydrogen atoms in the alkyl group may be substituted with a halogen atom arbitrarily,

A^{LC1} and A^{LC2} independently represent a group selected from:

(a) a trans-1,4-cyclohexylene group (one CH₂ group or two or more non-adjacent CH₂ groups in this trans-1,4-cyclohexylene group may be substituted with an oxygen atom or a sulfur atom);
(b) a 1,4-phenylene group (one CH group or two or more non-adjacent CH groups in this 1,4-phenylene group may be substituted with a nitrogen atom); and
(c) a 1,4-bicyclo(2.2.2)octylene group, a naphthalene-2,6-diyl group, a decahydronaphthalene-2,6-diyl group, a 1,2,3,4-tetrahydronaphthalene-2,6-diyl group, and a chroman-2,6-diyl group, and one or two or more hydrogen atoms included in the group (a), the group (b), and the group (c) may be substituted with F, Cl, CF₃, or OCF₃,

Z^{LC} represents a single bond, —CH═CH—, —CF═CF—, —C≡C—, —CH₂CH₂—, —(CH₂)₄—, —OCH₂—, —CH₂O—, —OCF₂—, —CF₂O—, —COO—, or —OCO—,

Y^{LC} represents a hydrogen atom, a fluorine atom, a chlorine atom, a cyano group, or an alkyl group with 1 to 15 carbon atoms, and one or two or more CH₂ groups in the alkyl group may be substituted with —O—, —CH═CH—, —CO—, —OCO—. —COO—, —C≡C—, —CF₂O—, or —OCF₂— so that an oxygen atom is not directly adjacent, and one or two or more hydrogen atoms in the alkyl group may be substituted with a halogen atom arbitrarily,

“a” represents an integer of 1 to 4, and when “a” represents 2, 3, or 4 and there is a plurality of A^{LC1}, the plurality of A^{LC1} is either the same or different, and when there is a plurality of Z^{LC}, the plurality of Z^{LC} is either the same or different).

The compound represented by the general formula (LC) is preferably one kind or two or more kinds of compounds selected from the compounds represented by the following general formulae (LC1) and (LC2):

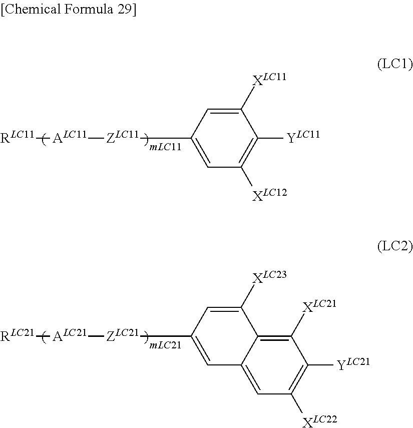

(in the formula, R^{LC11} and R^{LC21} independently represent an alkyl group with 1 to 15 carbon atoms, and one or two or more CH₂ groups in the alkyl group may be substituted with —O—, —CH═CH—, —CO—, —OCO—, —COO— or —C≡C— so that an oxygen atom is not directly adjacent, and one or two or more hydrogen atoms in the alkyl group may be substituted with a halogen atom arbitrarily, and A^{LC11} and A^{LC21} independently represent any of the following structures:

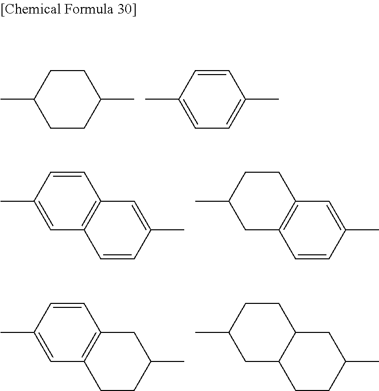

(in the structure, one or two or more CH₂ groups in the cyclohexylene group may be substituted with an oxygen atom, one or two or more CH groups in the 1,4-phenylene group may be substituted with a nitrogen atom, and one or two or more hydrogen atoms in the structure may be substituted with F, Cl, CF₃, or OCF₃), X^{LC11}, X^{LC12}, and X^{LC21} to X^{LC23} independently represent a hydrogen atom. F, Cl, CF₃, or OCF₃, Y^{LC11} and Y^{LC21} independently represent a hydrogen atom, Cl, F, CN, CF₃, OCH₂F, OCHF₂, or OCF₃, Z^{LC11} and Z^{LC21} independently represent a single bond, —CH═CH—, —CF═CF—, —C≡C—, —CH₂CH₂—, —(CH₂)₄—, —OCH₂—, —CH₂O—, —OCF₂—, —CF₂O—, —COO—, or —OCO—, m^{LC11} and m^{LC21} independently represent an integer of 1 to 4, and when there is a plurality of A^{LC11}, A^{LC21}, Z^{LC11}, and Z^{LC21}, the plurality of A^{LC11}, A^{LC21}, Z^{LC11}, and Z^{LC21} is either the same or different).

R^{LC11} and R^{LC21} preferably represent independently an alkyl group with 1 to 7 carbon atoms, an alkoxy group with 1 to 7 carbon atoms, or an alkenyl group with 2 to 7 carbon atoms, more preferably an alkyl group with 1 to 5 carbon atoms, an alkoxy group with 1 to 5 carbon atoms, or an alkenyl group with 2 to 5 carbon atoms, and much more preferably a linear form. As the alkenyl group, the following structure is the most preferable:

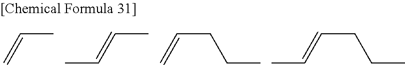

(in the formula, this compound is bonded to a cyclic structure at the right end).

It is preferable that A^{LC11} and A^{LC21} independently represent the following structure:

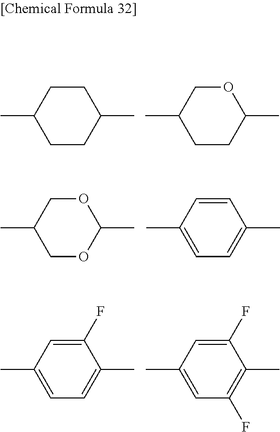

Y^{LC11} and Y^{LC21} preferably represent independently F, CN, CF₃, or OCF₃, preferably F or OCF₃, and particularly preferably F.

Z^{LC11} and Z^{LC21} are preferably a single bond, —CH₂CH₂—, —COO—, —OCO—, —OCH₂—, —CH₂O—, —OCF₂—, or —CF₂O—, preferably a single bond, —CH₂CH₂—, —OCH₂—, —OCF₂—, or —CF₂O—, and more preferably a single bond, —OCH₂— or —CF₂O—.

Note that m^{LC11} and m^{LC21} are preferably 1, 2, or 3, and preferably 1 or 2 if the preservation stability at low temperature and the response speed are considered important, and preferably 2 or 3 if the upper limit of the upper-limit temperature of the nematic phase is desired to be improved.

The general formula (LC1) is preferably one kind or two or more kinds of compounds selected from the compounds represented by the following general formulae (LC1-a) to (LC1-c):

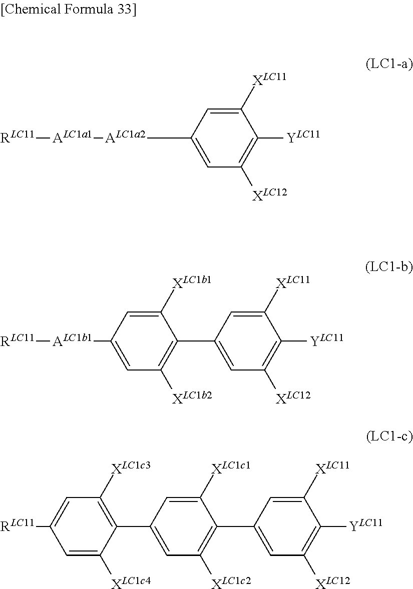

(in the formula, R^{LC11}, Y^{LC11}, X^{LC11} and X^{LC12} independently represent the same as R^{LC11}, Y^{LC11}, X^{LC11}, and X^{LC12} in the general formula (LC1), A^{LC1a1}, A^{LC1a2}, and A^{LC1b1} represent a trans-1,4-cyclohexylene group, a tetrahydropyran-2,5-diyl group, and a 1,3-dioxane-2,5-diyl group, and X^{LC1b1}, X^{LC1b2}, and X^{LC1c1} to X^{LC1c4} independently represent a hydrogen atom, Cl, F, CF₃, or OCF₃).

R^{LC11} preferably represents independently an alkyl group with 1 to 7 carbon atoms, an alkoxy group with 1 to 7 carbon atoms, or an alkenyl group with 2 to 7 carbon atoms, and more preferably an alkyl group with 1 to 5 carbon atoms, an alkoxy group with 1 to 5 carbon atoms, or an alkenyl group with 2 to 5 carbon atoms.

X^{LC11} to X^{LC1c4} preferably represent independently a hydrogen atom or F.

Y^{LC11} preferably represent independently F, CF₃, or OCF₃.

The general formula (LC1) is preferably one kind or two or more kinds of compounds selected from the compounds represented by the following formulae (LC1-d) to (LC1-o):

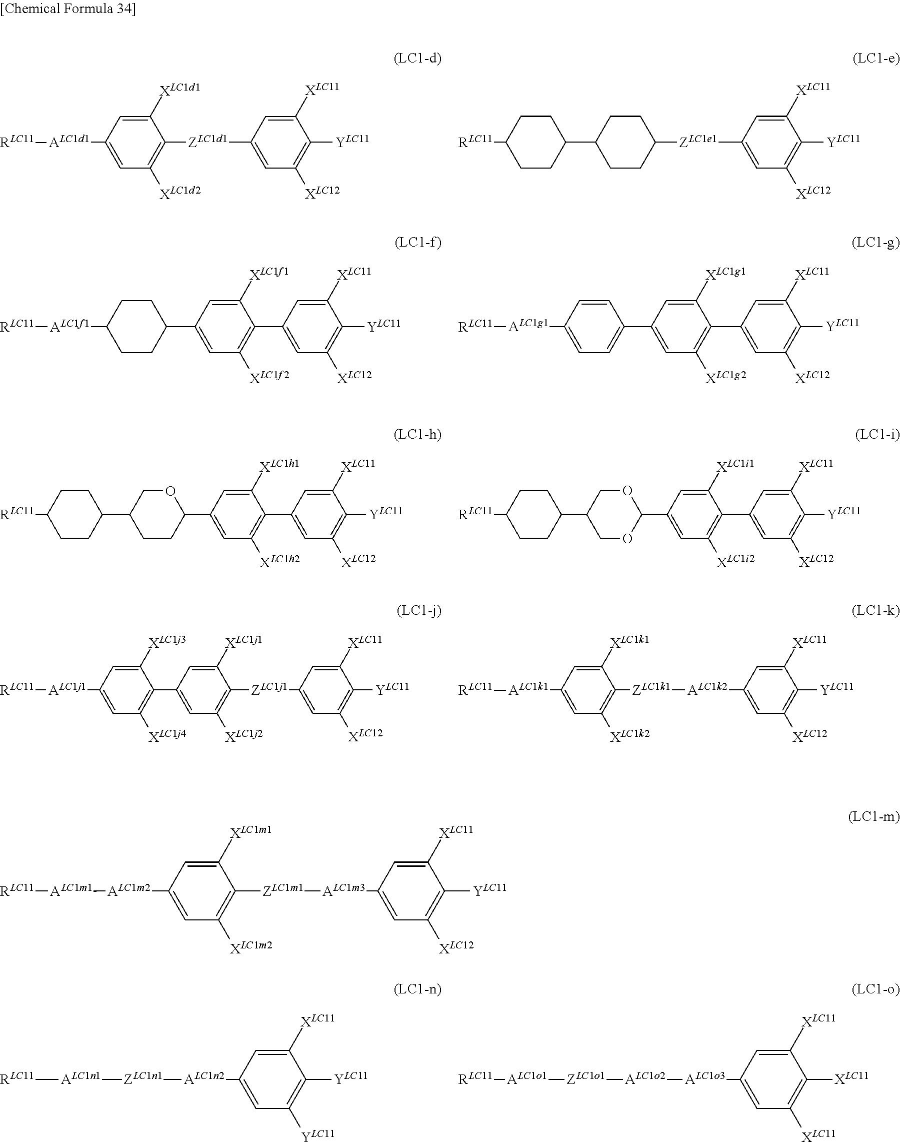

(in the formula, R^{LC11}, Y^{LC11}, X^{LC11}, and X^{LC12} independently represent the same as R^{LC11}, Y^{LC11}, X^{LC11}, and X^{LC12} in the general formula (LC1), A^{LC1d1}, A^{LC1f1}, A^{LC1g1}, A^{LC1j1}, A^{LC1k1}, A^{LC1k2}, A^{LC1m1} to A^{LC1m3}, A^{LC1n1}, A^{LC1n2}, and A^{LC1o1} to A^{LC1o1} represent a 1,4-phenylene group, a trans-1,4-cyclohexylene group, a tetrahydropyran-2,5-diyl group, or a 1,3-dioxane-2,5-diyl group, X^{LC1d1}, X^{LC1d2}, X^{LC1f1}, X^{LC1f2}, X^{LC1g1}, X^{LC1g2}, X^{LC1h1}, X^{LC1b2}, X^{LC1i1}, X^{LC1i2}, X^{LC1j1} to X^{LC1j4}, X^{LC1k1}, X^{LC1k1}, X^{LC1m1} and X^{LC1m2} independently represent a hydrogen atom, Cl, F, CF₃, or OCF₃, and Z^{LC1d1}, Z^{LC1e1}, Z^{LC1j1}, Z^{LC1k1}, Z^{LC1m1}, Z^{LC1n1}, and Z^{LC1o1} independently represent a single bond, —CH═CH—, —CF═CF—, —C≡C—, —CH₂CH₂—, —(CH₂)₄—, —OCH₂—, —CH₂O—, —OCF₂—, —CF₂O—, —COO—, or —OCO—).

R^{LC11} preferably represents independently an alkyl group with 1 to 7 carbon atoms, an alkoxy group with 1 to 7 carbon atoms, or an alkenyl group with 2 to 7 carbon atoms, and more preferably an alkyl group with 1 to 5 carbon atoms, an alkoxy group with 1 to 5 carbon atoms, or an alkenyl group with 2 to 5 carbon atoms.

X^{LC11} to X^{LC1m2} preferably represent independently a hydrogen atom or F.

Y^{LC11} preferably represent independently F, CF₃, or OCF₃.

Z^{LC1d1} to Z^{LC1m1} preferably represent independently —CF₂O— or —OCH₂.

The general formula (LC2) is preferably one kind or two or more kinds of compounds selected from the compounds represented by the following formulae (LC2-a) to (LC2-i):

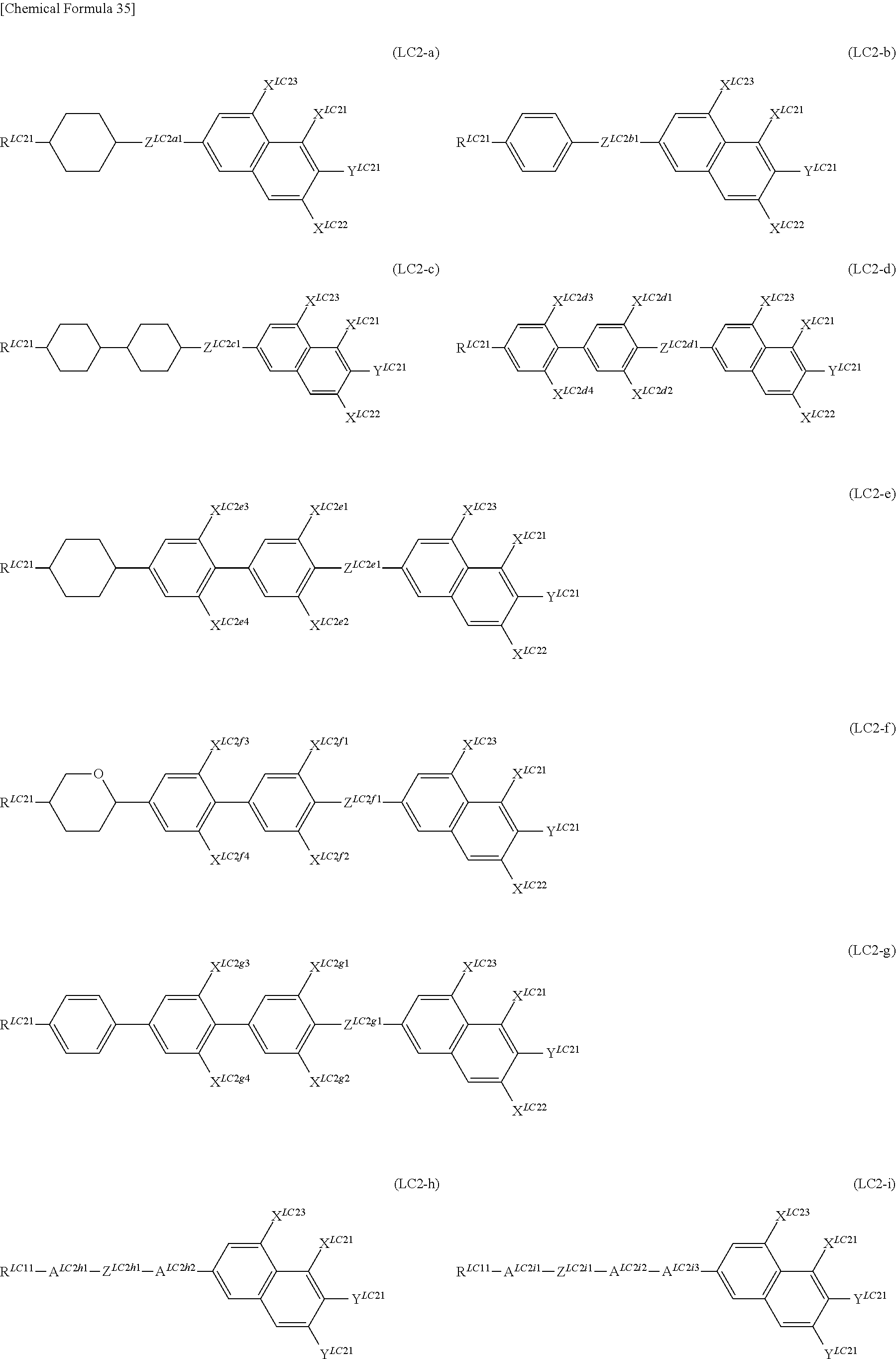

(in the formula, R^{LC21}, Y^{LC21}, and X^{LC21} to X^{LC23} independently represent the same as R^{LC21}, Y^{LC21}, and X^{LC21} to X^{LC23} in the general formula (LC2), X^{LC2d1} to X^{LC2d4}, X^{LC2e1} to X^{LC2e4}, X^{LC2f1} to X^{LC2f4}, and X^{LC2g1} to X^{LC2g4} independently represent a hydrogen atom, Cl, F, CF₃, or OCF₃, A^{LC2h1}, A^{LC2h1}, and A^{LC2h1} to A^{LC2h3} represent a 1,4-phenylene group, a trans-1,4-cyclohexylene group, a tetrahydropyran-2,5-diyl group, a 1,3-dioxane-2,5-diyl group, and Z^{LC2a1}, Z^{LC2b1}, Z^{LC2e1}, Z^{LC2d1}, Z^{LC2e1}, Z^{LC2f1}, Z^{LC2g1}, Z^{LC2h1} and Z^{LC2i1} independently represent a single bond, —CH═CH—, —CF═CF—, —C≡C—, —CH₂CH₂—, —(CH₂)₄—, —OCH₂—, —CH₂O—, —OCF₂—, —CF₂O—, —COO—, or —OCO—).

R^{LC21} preferably represents independently an alkyl group with 1 to 7 carbon atoms, an alkoxy group with 1 to 7 carbon atoms, or an alkenyl group with 2 to 7 carbon atoms, and more preferably an alkyl group with 1 to 5 carbon atoms, an alkoxy group with 1 to 5 carbon atoms, or an alkenyl group with 2 to 5 carbon atoms.

X^{LC21} to X^{LC2g4} preferably represent independently a hydrogen atom or F, and Y^{LC21} preferably represents independently F, CF₃, or OCF₃.

Z^{LC2a1} to Z^{LC2g4} preferably represent independently —CF₂O— or —OCH₂—.

The compound represented by the general formula (LC) is preferably one kind or two or more kinds of compounds selected from the compounds represented by the following general formulae (LC3) to (LC5):

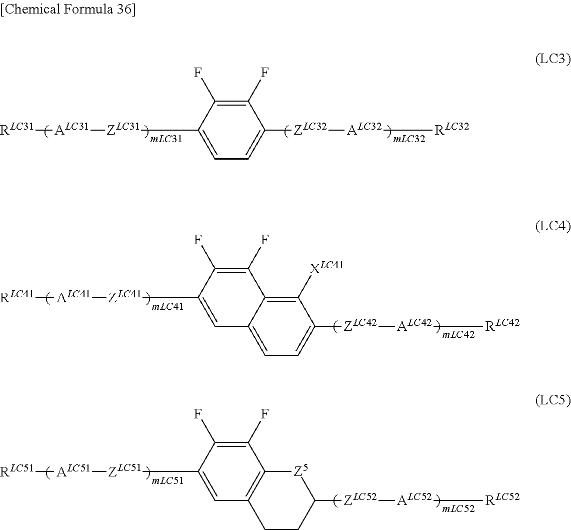

(in the formula, R^{LC31}, R^{LC32}, R^{LC41}, R^{LC42}, R^{LC51} and R^{LC52} independently represent an alkyl group with 1 to 15 carbon atoms, and one or two or more CH₂ groups in the alkyl group may be substituted with —O—, —CH═CH—, —CO—, —OCO—, —COO—, or —C≡C— so that an oxygen atom is not directly adjacent, and one or two or more hydrogen atoms in the alkyl group may be substituted with a halogen atom arbitrarily, and A^{LC31}, A^{LC32}, A^{LC41}, A^{LC42}, A^{LC51} and A^{LC52} preferably represent independently any of the following structures:

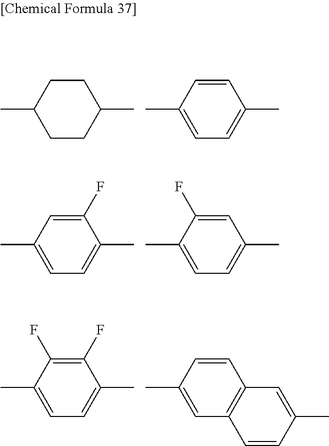

(in this structure, one or two or more CH₂ groups in the cyclohexylene group may be substituted with an oxygen atom, one or two or more CH groups in the 1,4-phenylene group may be substituted with a nitrogen atom, and one or two or more hydrogen atoms in the structure may be substituted with Cl, CF₃, or OCF₃), Z^{LC31}, Z^{LC32}, Z^{LC41}, Z^{LC42}, Z^{LC51}, and Z^{LC51} independently represent a single bond, —CH═CH—, —C≡C—, —CH₂CH—, —(CH₂)₄—, —COO—, —OCH₂, —CH₂O—, —OCF₂—, or —CF₂O—, Z⁵ represents a CH₂ group or an oxygen atom, X^{LC41} represents a hydrogen atom or a fluorine atom, m^{LC31}, m^{LC32}, m^{LC41}, m^{LC42}, m^{LC51}, and m^{LC52} independently represent 0 to 3, m^{LC31}+m^{LC32}, m^{LC41}+m^{LC42}, and m^{LC51}+m^{LC52} represent 1, 2, or 3, and when there is a plurality of A^{LC31} to A^{LC52} and Z^{LC31} to Z^{LC52}, the plurality of A^{LC31} to A^{LC52} and Z^{LC31} to Z^{LC52} is either the same or different).

R^{LC31} to R^{LC52} preferably represent independently an alkyl group with 1 to 7 carbon atoms, an alkoxy group with 1 to 7 carbon atoms, and an alkenyl group with 2 to 7 carbon atoms, and as the alkenyl group, the following structure is the most preferable:

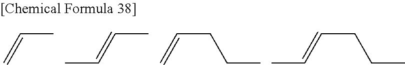

(in the formula, the compound is bonded to the cyclic structure at the right end).

A^{LC31} to A^{LC52} preferably represent independently the following structure:

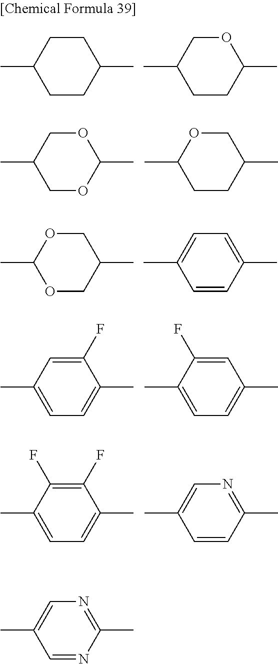

Z^{LC31} to Z^{LC51} preferably represent independently a single bond, —CH₂O—, —COO—, —OCO—, —CH₂CH₂—, —CF₂O—, —OCF₂—, or —OCH₂—.

The general formula (LC3) is preferably one kind or two or more kinds of compounds selected from the compounds represented by the following general formulae (LC3-a) and (LC3-b):

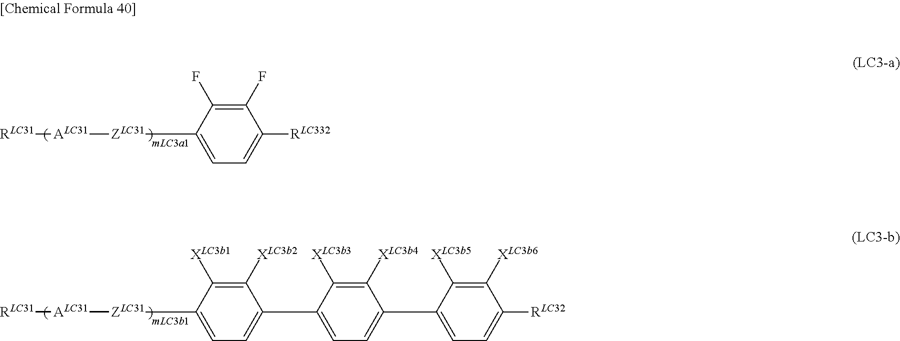

(in the formula, R^{LC31}, R^{LC32}, A^{LC31}, and Z^{LC31} represent independently the same as R^{LC31}, R^{LC32}, A^{LC31}, and Z^{LC31} in the general formula (LC3), X^{LC3b1} to X^{LC3b6} represent a hydrogen atom or a fluorine atom, at least one of the combination of X^{LC3b1} and X^{LC3b2} and the combination of X^{LC3b3} and X^{LC3b4} represent fluorine atoms together, m^{LC3a1} represents 1, 2, or 3, m^{LC3b1} represents 0 or 1, and when there is a plurality of A^{LC31} and Z^{LC31}, the plurality of A^{LC31} and Z^{LC31} is either the same or different).

R^{LC31} and R^{LC32} preferably represent independently an alkyl group with 1 to 7 carbon atoms, an alkoxy group with 1 to 7 carbon atoms, an alkenyl group with 2 to 7 carbon atoms, or an alkenyloxy group with 2 to 7 carbon atoms.

A^{LC31} preferably represents a 1,4-phenylene group, a trans-L 4-cyclohexylene group, a tetrahydropyran-2,5-diyl group, or a 1,3-dioxane-2,5-diyl group, and more preferably a 1,4-phenylene group or a trans-1,4-cyclohexylene group.

Z^{LC31} preferably represents a single bond, —CH₂O—, —COO—. —OCO—, or —CH₂CH₂—, and more preferably a single bond.

As the general formula (LC3-a), any of the following formulae (LC3-a1) to (LC3-a6) is preferable:

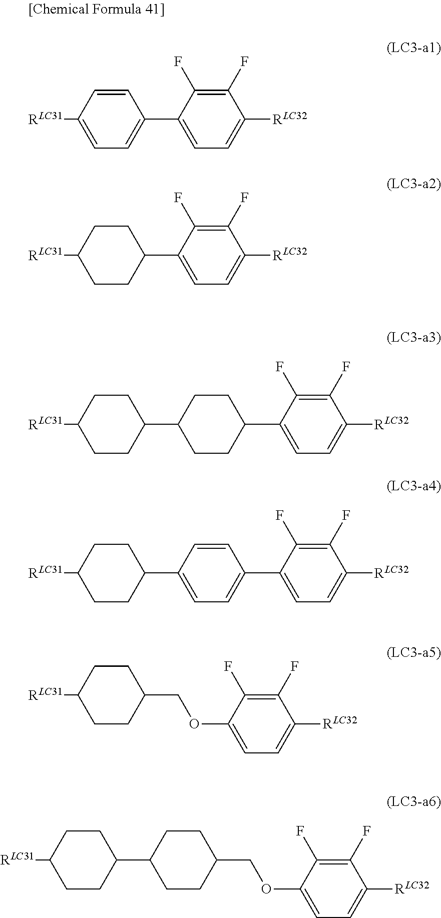

(in the formula, R^{LC31} and R^{LC32} independently represent the same as R^{LC31} and R^{LC32} in the general formula (LC3)).

It is preferable that R^{LC31} and R^{LC32} represent independently an alkyl group with 1 to 7 carbon atoms, an alkoxy group with 1 to 7 carbon atoms, and an alkenyl group with 2 to 7 carbon atoms, and it is more preferable that R^{LC31} represents an alkyl group with 1 to 7 carbon atoms and that R^{LC32} represents an alkoxy group with 1 to 7 carbon atoms.

The general formula (LC3-b) preferably represents any of the following general formulae (LC3-b1) to (LC3-b13), more preferably any of the general formulae (LC3-b1), (LC3-b6), (LC3-b8), (LC3-b11), and (LC3-b13), and much more preferably any of the general formulae (LC3-b1) and (LC3-b6), and the most preferably the general formula (LC3-b1):

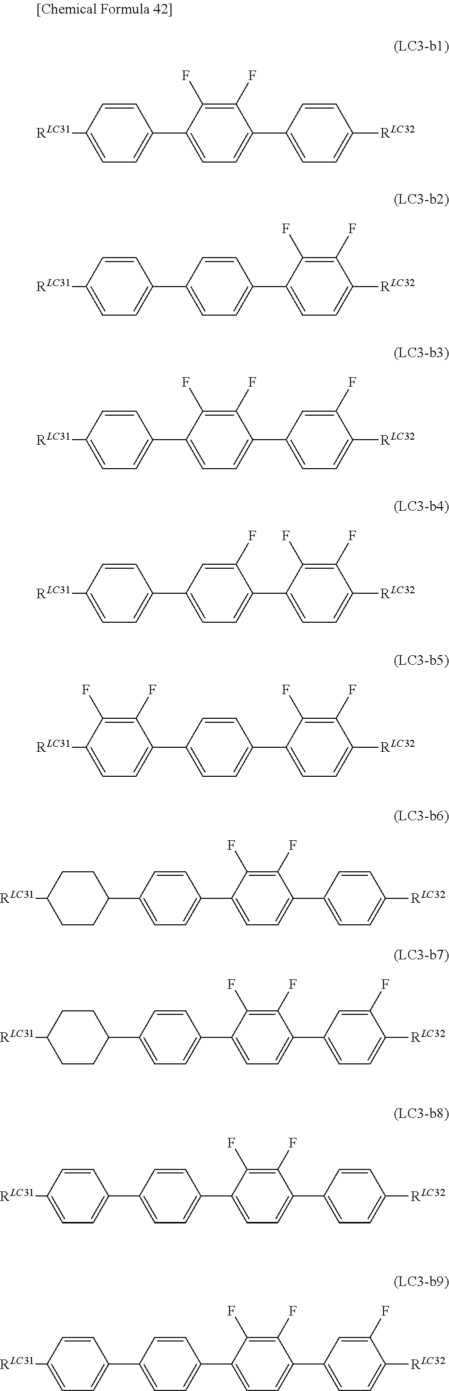

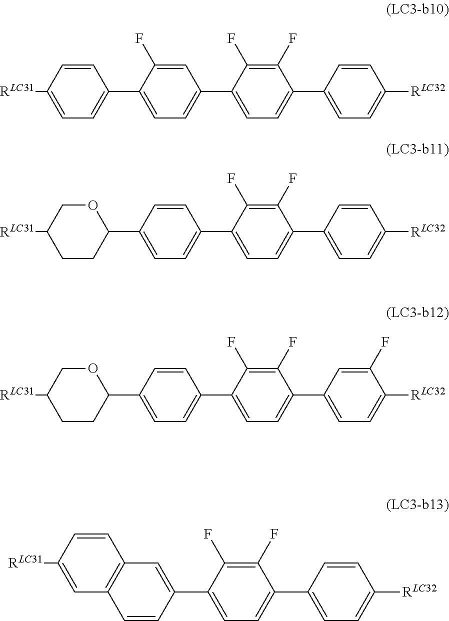

(in the formula, R^{LC31} and R^{LC32} independently represent the same as R^{LC31} and R^{LC32} in the general formula (LC3)).

It is preferable that R^{LC31} and R^{LC32} represent independently an alkyl group with 1 to 7 carbon atoms, an alkoxy group with 1 to 7 carbon atoms, and an alkenyl group with 2 to 7 carbon atoms, and it is more preferable that R^{LC31} represents an alkyl group with 2 or 3 carbon atoms and that R^{LC32} represents an alkyl group with 2 carbon atoms.

The general formula (LC4) is preferably one kind or two or more kinds of compounds selected from the compounds represented by the following general formulae (LC4-a) to (LC4-c) and the general formula (LC5) is preferably one kind or two or more kinds of compounds selected from the compounds represented by the following general formulae (LC5-a) to (LC5-c):

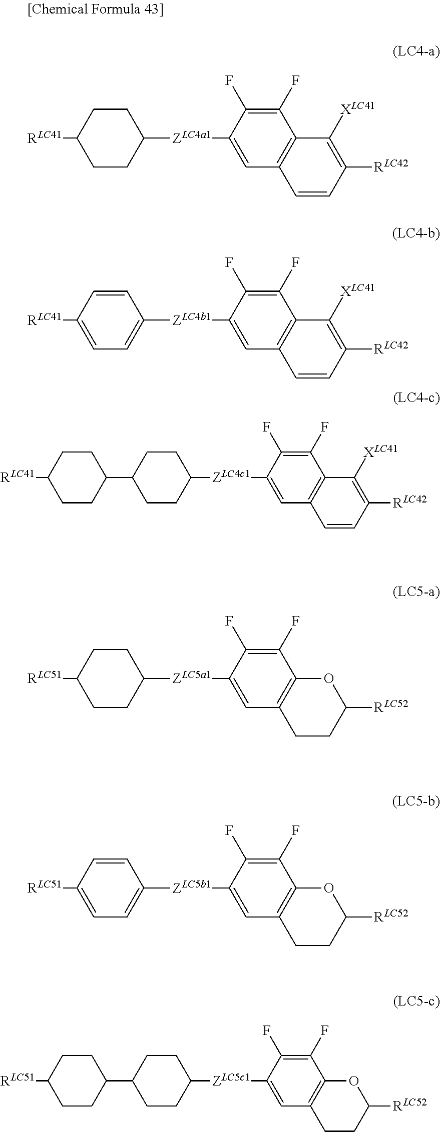

(in the formula, R^{LC41}, R^{LC42}, and X^{LC41} independently represent the same as R^{LC41}, R^{LC42}, and X^{LC41} in the general formula (LC4), R^{LC51} and R^{LC52} independently represent the same as R^{LC51} and R^{LC52} in the general formula (LC5), and Z^{LC4a1}, Z^{LC4b1}, Z^{LC4c1}, Z^{LC5a1}, Z^{LC5b1}, and Z^{LC5c1} independently represent a single bond, —CH═CH—, —C≡C—, —CH₂CH₂—, —(CH₂)₄—, —COO—, —OCH₂—, —CH₂O—, —OCF₂—, or —CF₂O—).

R^{LC41}, R^{LC42}, R^{LC51}, and R^{LC52} preferably represent independently an alkyl group with 1 to 7 carbon atoms, an alkoxy group with 1 to 7 carbon atoms, an alkenyl group with 2 to 7 carbon atoms, or an alkenyloxy group with 2 to 7 carbon atoms.

Z^{LC4a1} to Z^{LC5c1} preferably represent independently a single bond, —CH₂O—, —COO—, —OCO—, or —CH₂CH₂—, and more preferably a single bond.

The compound represented by the general formula (LC) is preferably the liquid crystal composition containing one kind or two or more kinds of compounds represented by the following general formula (LC6):

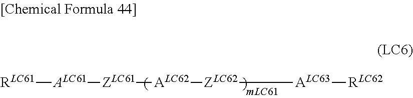

(in the formula, R^{LC61} and R^{LC62} independently represent an alkyl group with 1 to 15 carbon atoms, one or two or more CH₂ groups in the alkyl group may be substituted with —O—, —CH═CH—, —CO—, —OCO—, —COO—, or —C≡C— so that an oxygen atom is not directly adjacent, one or two or more hydrogen atoms in the alkyl group may be arbitrarily substituted with a halogen, and A^{LC61} to A^{LC63} represent independently any of the following:

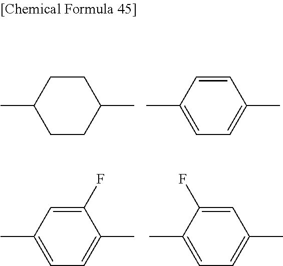

(in the structure, one or two or more CH₂CH₂ groups in the cyclohexylene group may be substituted with —CH═CH—, —CF₂O—, or —OCF₂— and one or two or more CH groups in the 1,4-phenylene group may be substituted with a nitrogen atom), Z^{LC61} and Z^{LC62} independently represent a single bond, —CH═CH—, —C≡C—, —CH₂CH₂—, —(CH₂)₄—, —COO—, —OCH₂—, —CH₂O—, —OCF₂— or —CF₂O—, and mⁱⁱⁱ¹ represents 0 to 3 but the compounds represented by the general formulae (LC1) to (LC6) are excluded).

R^{LC61} and R^{LC62} preferably represent independently an alkyl group with 1 to 7 carbon atoms, an alkoxy group with 1 to 7 carbon atoms, and an alkenyl group with 2 to 7 carbon atoms, and as the alkenyl group, the following structure is the most preferable:

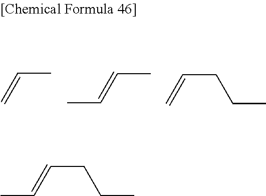

(in the formula, the compound is bonded to the cyclic structure at the right end).

A^{LC61} to A^{LC63} preferably represent independently the following structure:

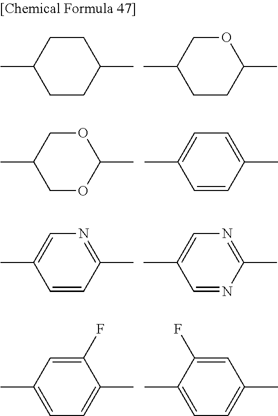

Z^{LC61} and Z^{LC62} preferably represent independently a single bond, —CH₂CH₂—, —COO—, —OCH₂—, —CH₂O—, —OCF₂—, or —CF₂O—.

The general formula (LC6) is more preferably one kind or two or more kinds of compounds selected from the compounds represented by the following general formulae (LC6-a) to (LC6-m):

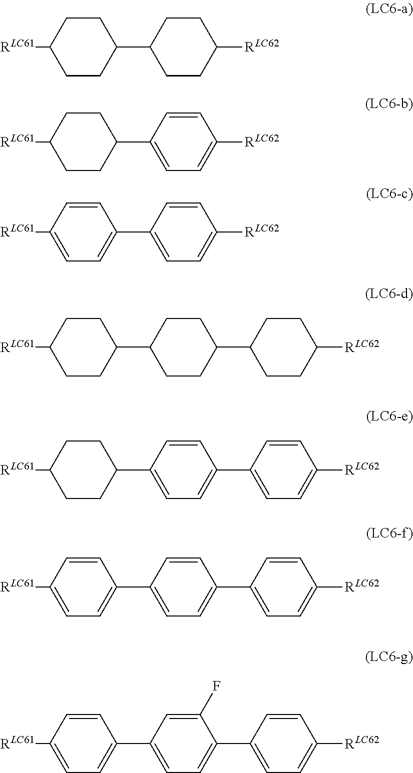

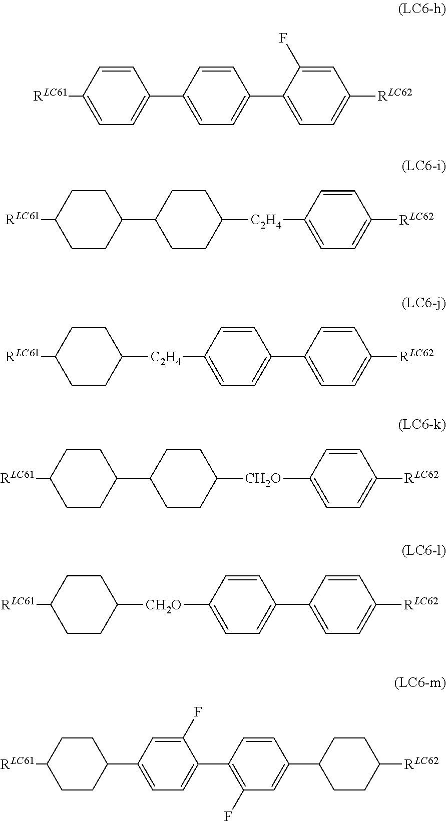

(in the formula, R^{LC61} and R^{LC62} independently represent an alkyl group with 1 to 7 carbon atoms, an alkoxy group with 1 to 7 carbon atoms, an alkenyl group with 2 to 7 carbon atoms, or an alkenyloxy group with 2 to 7 carbon atoms).

The liquid crystal composition according to the present invention may further contain a compound represented by a general formula (Q):

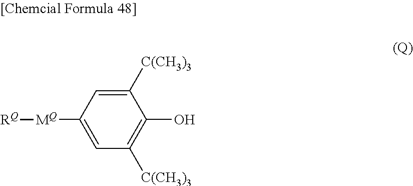

In the formula, R^{Q} represents a linear alkyl group or a branched alkyl group with 1 to 22 carbon atoms, and one CH₂ group or two or more non-adjacent CH₂ groups in the group may be substituted with —O—, —CH═CH—, —CO—, —OCO—, —COO—, —C≡C—, —CF₂O—, or —OCF₂—.

M^{Q} represents a trans-1,4-cyclohexylene group, a 1,4-phenylene group, or a single bond.

Specifically, the compound represented by the general formula (Q) is preferably any of compounds represented by the following general formulae (Q-a) to (Q-e):

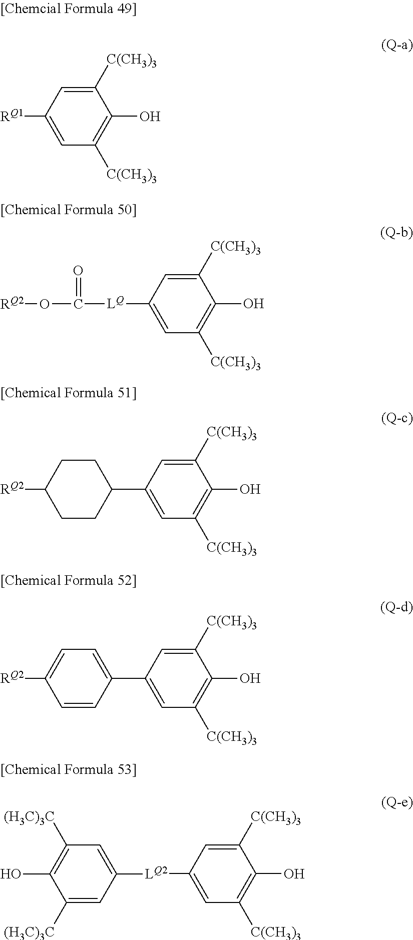

In the formula, R^{Q1} preferably represents a linear alkyl group or a branched alkyl group with 1 to 10 carbon atoms.

R^{Q2} preferably represents a linear alkyl group or a branched alkyl group with 1 to 20 carbon atoms.

R^{Q3} preferably represents a linear alkyl group or a branched alkyl group, a linear alkoxy group, or a branched alkoxy group with 1 to 8 carbon atoms.

L^{Q} preferably represents a linear alkylene group or a branched alkylene group with 1 to 8 carbon atoms.

L^{Q2} preferably represents a linear alkylene group or a branched alkylene group with 2 to 12 carbon atoms.

Among the compounds represented by the general formulae (Q-a) to (Q-e), the compounds represented by the general formulae (Q-c), (Q-d), and (Q-e) are more preferable.

The liquid crystal composition according to the present invention contains one kind or two or more kinds of the compounds represented by the general formula (Q), and preferably contains one to five kinds thereof, more preferably one to three kinds thereof and particularly preferably one kind thereof. The content is preferably 0.001 mass % to 1 mass %, more preferably 0.001 mass % to 0.1 mass %, and particularly preferably 0.001 mass % to 0.05 mass %.

The polymerizable compound containing liquid crystal composition according to the present invention contains the polymerizable compound represented by the general formula (1) preferably by 0.41 mass % or more and 10 mass % or less in total. The polymerizable compound containing liquid crystal composition according to the present invention fails to have the sufficient UV resistance if containing the polymerizable compound represented by the general formula (1) by less than 0.41 mass % in total. This is because the polymerizable compound plays an important role in improving the UV resistance in the polymerizable compound containing liquid crystal composition according to the present invention. That is to say, the polymerizable compound containing liquid crystal composition according to the present invention has higher UV resistance as containing the polymerizable compound in larger amount. It is supposed that this is because the polymerizable compound and its polymer operate to protect the liquid crystal compound from UV light. This operation is remarkably observed from the polymerizable compounds represented by the formulae (1a-1) to (1a-30), the polymerizable compounds represented by the formulae (1 b-1) to (1b-34), the polymerizable compounds represented by the formulae (1c-1) to (1c-52), the polymerizable compounds represented by the formulae (1d-1) to (1d-36), and the similar polymerizable compounds, and particularly the polymerizable compounds represented by the formulae (1d-1) to (1d-36) and the similar polymerizable compounds. On the other hand, if the polymerizable compound containing liquid crystal composition according to the present invention contains a too large amount of polymerizable compound represented by the general formula (1), the physical property values other than the UV resistance, such as the refractive index anisotropy (Δn), the nematic phase-isotropic liquid phase transition temperature (Tₙᵢ), the viscosity (η), the rotational viscosity (γ₁), the elastic constant (K₃₃), and the dielectric anisotropy (Δ∈), deteriorate; therefore, the total content of the polymerizable compound represented by the general formula (1) is preferably 10 mass % or less.

In the polymerizable compound containing liquid crystal composition according to the present invention, the total content of the polymerizable compound represented by the general formula (1) is more preferably 0.46 mass % or more and 5 mass % or less. The total content of the polymerizable compound represented by the general formula (1) is much more preferably 0.51 mass % or more and 3 mass % or less, and the most preferably 0.56 mass % or more and 2 mass % or less.

When the polymerizable compound containing liquid crystal composition according to the present invention has the positive dielectric anisotropy (Δ∈), the dielectric anisotropy (Δ∈) at 25° C. ranges from 2.0 to 20.0, and preferably ranges from 4.0 to 18.0, more preferably 4.0 to 16.0, and particularly preferably 4.0 to 14.0.

When the polymerizable compound containing liquid crystal composition according to the present invention has the negative dielectric anisotropy (Δ∈), the dielectric anisotropy (Δ∈) at 25° C. ranges from −1.5 to −8.0, and preferably ranges from −2.0 to −6.0, more preferably from −2.0 to −5.0, and particularly preferably from −2.5 to −4.0.

The refractive index anisotropy (Δn) of the polymerizable compound containing liquid crystal composition according to the present invention at 20° C. ranges from 0.08 to 0.14, more preferably ranges from 0.09 to 0.13, and particularly preferably from 0.09 to 0.12. More specifically, the refractive index anisotropy preferably ranges from 0.10 to 0.13 for the thin cell gap, and preferably from 0.08 to 0.10 for the thick cell gap.

The viscosity (η) of the polymerizable compound containing liquid crystal composition according to the present invention at 20° C. ranges from 10 to 30 mPa·s, more preferably ranges from 10 to 25 mPa·s, and particularly preferably from 10 to 20 mPa·s.

The rotational viscosity (γ₁) of the polymerizable compound containing liquid crystal composition according to the present invention at 20° C. ranges from 50 to 130 mPa·s, more preferably ranges from 50 to 110 mPa·s, and particularly preferably from 50 to 90 mPa·s.

The nematic phase-isotropic liquid phase transition temperature (Tₘ) of the polymerizable compound containing liquid crystal composition according to the present invention ranges from 60° C. to 120° C., more preferably from 70° C. to 110° C., and particularly preferably from 70° C. to 100° C.

The liquid crystal display element including the polymerizable compound containing liquid crystal composition according to the present invention has characteristics of the high UV resistance and the high-speed response, and particularly is useful as the liquid crystal display element for the active matrix driving and applicable to the VA mode, the PSVA mode, the PSA mode, the IPS mode, or the ECB mode.

A liquid crystal display element including the polymerizable compound containing liquid crystal composition according to the present invention is preferably a liquid crystal display element including a liquid crystal layer formed between a pair of substrates, a transparent electrode, and a polarization plate. The polymerizable compound containing liquid crystal composition according to the present invention is housed in a space between the pair of substrates and the liquid crystal can be aligned by polymerizing the polymerizable compound in the liquid crystal layer. The liquid crystal display element may be the PSVA mode, PSA mode, or PS-IPS mode liquid crystal display element.

The two substrates for the liquid crystal cell, which are used for the liquid crystal display element including the polymerizable liquid crystal compound containing liquid crystal composition according to the present invention, may be formed of glass or a flexible transparent material like plastic, and one of the two substrates may be formed of an opaque material such as silicon. A transparent substrate with a transparent electrode layer may be formed by, for example, sputtering indium tin oxide (ITO) on a transparent substrate such as a glass plate.

A color filter can be formed by, for example, a pigment dispersion method, a printing method, an electrodeposition method, a dyeing method, or the like. In an example of the method of forming the color filter by the pigment dispersion method, a curable color composition for the color filter is applied onto the transparent substrate and patterned, and then cured by being heated or irradiated with light. This process is carried out for each of red, green, blue, and/or other colors, so that the pixel portion for the color filter can be formed. Moreover, a pixel electrode having active elements such as a TFT, a thin film diode, or a metal-insulator-metal resistive element may be provided on the substrate.

The polymerizable compound containing liquid crystal composition according to the present invention may be held between the two substrates by, for example, a normal vacuum injection method or ODF method. First, the substrates are disposed opposite to each other so that the transparent electrode layer comes inside. Here, the distance between the substrates may be adjusted using the spacer. The distance is preferably adjusted so that the thickness of the light adjustment layer to be obtained ranges from 1 to 100 μm, and more preferably 1.5 to 10 μm. In the case of using the polarization plate, the product of the refractive index anisotropy Δn and the cell thickness d of the liquid crystal is preferably adjusted so that the contrast is maximized. If two polarization plates are used, the polarization axis of each polarization plate may be adjusted to improve the viewing angle or the contrast. In addition, a retardation film for increasing the viewing angle can be used. Examples of the spacer include glass particles, plastic particles, alumina particles, and photoresist material. After that, a sealing agent such as a thermosetting or photosensitive composition is used to seal between the substrates maintaining a certain gap therebetween by an appropriate method selected depending on the injection method.

As the method of polymerizing the polymerizable compound, the irradiation with the active energy beam such as UV light or the electron beam is preferable because the rapid polymerization is desired. In the case of using the UV light, the light source of polarized light or the light source of non-polarized light may be used. In the case of polymerizing the polymerizable compound containing liquid crystal composition according to the present invention with the compound held between the two substrates, it is necessary that at least the substrate to be irradiated is transparent to the active energy beam as appropriate. In another method, just the particular part of the compound is polymerized using the mask in the irradiation and then by changing the condition such as the electric field, the magnetic field, or the temperature, the aligned state of the non-polymerized part is changed and furthermore, the irradiation with the active energy beam is carried out for the polymerization. In particular, to manufacture the PSVA mode or the PSA mode liquid crystal display element, it is preferable to expose the polymerizable compound containing liquid crystal composition to the UV light while applying the AC electric field to the composition. The AC electric field to be applied is preferably AC with a frequency of 10 Hz to 10 kHz, more preferably 50 Hz to 10 kHz, and the voltage is selected in accordance with the desired pre-tilt angle of the liquid crystal display element. That is to say, the pre-tilt angle of the liquid crystal display element can be controlled by the voltage to be applied. In the case of the MVA mode liquid crystal display element, the pre-tilt angle is preferably controlled in the range of 80° to 89° from the aspect of the alignment stability and the contrast.

The temperature in the irradiation with the active energy beam is preferably in the range where the liquid crystal state of the liquid crystal composition according to the present invention is maintained. The polymerization is preferably carried out at around a room temperature, i.e., typically at 15 to 35° C. A lamp that generates the UV light may be a metal halide lamp, a high-pressure mercury lamp, ultrahigh-pressure mercury lamp, or the like. In regard to the wavelength of the UV light to be delivered, the UV light is preferably cut as necessary. The intensity of the UV light to be delivered is preferably 0.1 mW/cm² to 100 W/cm², and more preferably 2 mW/cm² to 50 W/cm². The amount of energy of the UV light can be adjusted as appropriate, and is preferably 10 mJ/cm² to 500 J/cm², more preferably 100 mJ/cm² to 200 J/cm². The intensity may be varied when the UV light is delivered. The length of time of the irradiation with the UV light is selected in accordance with the intensity of the UV light, and is preferably 10 seconds to 3600 seconds.

### EXAMPLES

The present invention will be further described with reference to Examples but the present invention is not limited thereto. In the description of Examples and Comparative Examples, “% o” refers to “mass %”. In Examples, the compounds are abbreviated as below and n represents a natural number.

### (Side Chain)

-n —CₙH₂ₙ₊₁ linear alkyl group with n carbon atoms
n- CₙH₂ₙ₊₁— linear alkyl group with n carbon atoms
—On —OCₙH₂ₙ₊₁ linear alkoxyl group with n carbon atoms
nO— CₙH₂ₙ₊₁O— linear alkoxyl group with n carbon atoms

### —V —CH═CH₂

### V— CH₂═CH—

### —V1 —CH═CH—CH₃

### 1V— CH₃—CH═CH—

-2V —CH₂—CH₂—CH═CH₃
V2- CH₃═CH—CH₂—CH₃—
-2V1 —CH₂—CH₂—CH═CH—CH₃
1V2- CH₃—CH═CH—CH₂—CH₂

### (Linking Group)

-n- —CₙH₂ₙ—
-nO— —CₙH₂ₙ—O—On- —O—CₙH₂ₙ—

### —COO— —C(═O)—O—

### —OCO— —O—C(═O)—

### —CF2O— —CF₂—O—

### —OCF2- —O—CF₂—

### (Cyclic Structure)

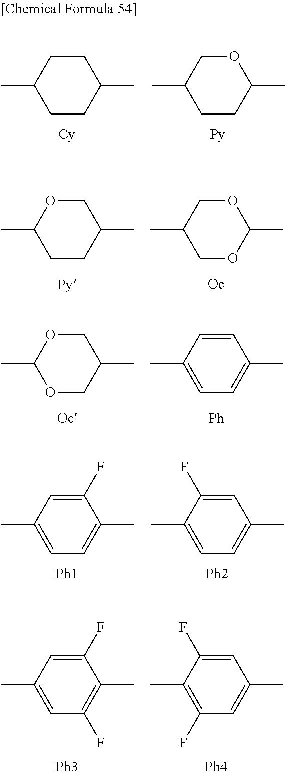

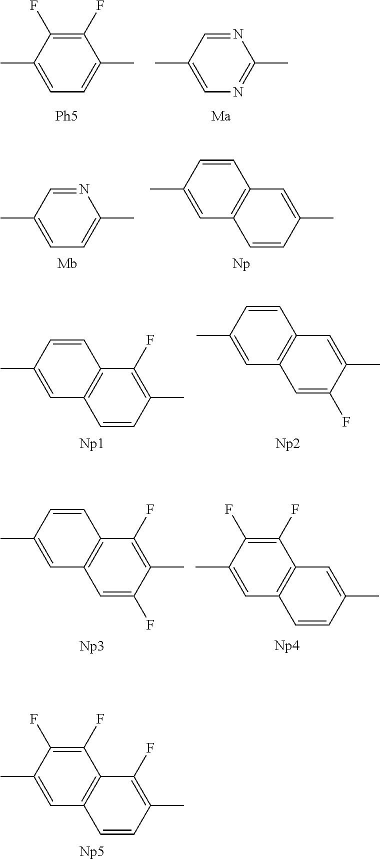

In Examples, the characteristics below were measured.

Tₙᵢ: nematic phase-isotropic liquid phase transition temperature (° C.)
T_{cn}: solid phase-nematic phase transition temperature (° C.)
Δn: refractive index anisotropy at 20° C.
Δ∈: dielectric anisotropy at 20° C.
η: viscosity at 20° C. (mPa·s)
γ₁: rotational viscosity at 20° C. (mPa·s)
K₃₃: elastic constant K₃₃ at 20° C. (pN)
Initial voltage holding ratio (VHR): VHR before UV irradiation (%)
Voltage holding ratio (VHR) after UV irradiation: VHR after UV irradiation (%)

For forming the test cell with the pre-tilt angle, the test cell was irradiated with UV with 60 J (365 nm) while the square wave voltage was applied thereto at 10 V and 100 Hz. The multi-light of USHIO was used as the UV light source.

For measuring the response speed of the sample, a test cell with a cell thickness of 3.5 μm and an alignment film of JALS2096 was used and Vsel was set to 5 V, Vnsel was set to 1 V, the temperature was set to 20° C., and DMS301 of AUTRONIC-MELCHERS was used.

For evaluating the UV resistance of the test cell, SP-7 (USHIO) was used and the cell was irradiated with UV light at 100 mW/cm⁻² for a predetermined period of time, and the VHR before and after the UV light irradiation was measured.

The VHR was measured using VHR-1 (TOYO Corporation) at 1 V, 60 Hz, and 60° C.

As typical examples of the polymerizable compound, (Ia-31), (Ib-1), (Ib-3), and (Id-29) were employed but the present invention is not limited to these polymerizable compounds.

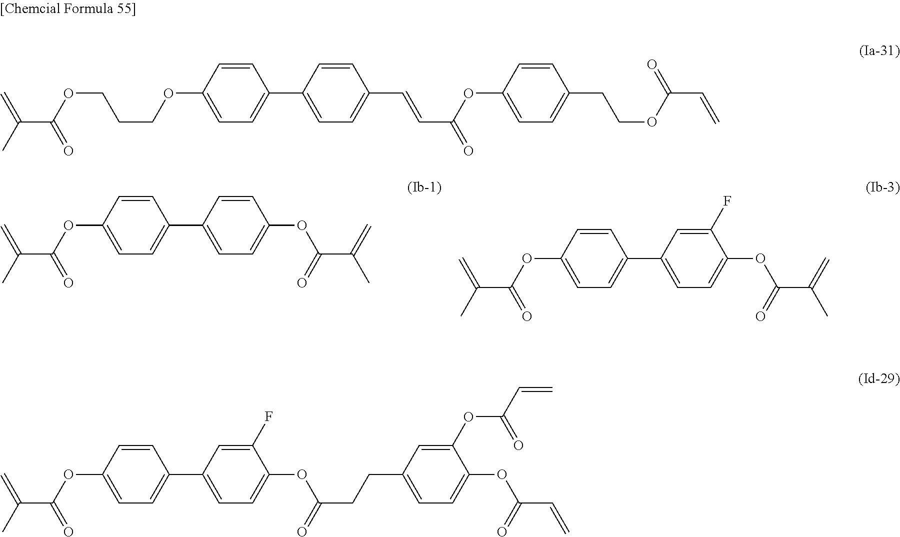

### Comparative Examples 1-1 to 3, Examples 1-1 to 15

LC-A was prepared as the matrix liquid crystal. The structures and the physical property values of the liquid crystal composition are as shown in Table 1.

TABLE 1

| | LC-A |
|---|---|
| 3-Cy—Cy-2 | 16.0% |
| 3-Cy—Cy-4 | 7.0% |
| 3-Cy—Cy-5 | 4.0% |
| 3-Ph—Ph—O1 | 3.0% |
| 5-Ph—Ph—O1 | 3.0% |
| 5-Ph—Ph-1 | 9.0% |
| 3-Cy—Cy—Ph-1 | 7.0% |
| 3-Cy—Cy—Ph-3 | 4.0% |
| 3-Cy—1O—Ph5—O1 | 6.0% |
| 3-Cy—1O—Ph5—O2 | 8.0% |
| 3-Cy—Ph—Ph5—O3 | 7.0% |
| 3-Cy—Ph—Ph5—O4 | 6.0% |
| 4-Cy—Ph—Ph5—O3 | 6.0% |
| 2-Cy—Cy—1O—Ph5—O2 | 6.0% |
| 3-Cy—Cy—1O—Ph5—O2 | 8.0% |
| Total | 100.0% |
| Tni [° C.] | 76 |
| Tcn [° C.] | −32 |
| Δn | 0.102 |
| Δε | −2.9 |
| γ₁ [mPa · s] | 122 |
| K₃₃ [pN] | 13.0 |
| γ₁/K₃₃ [mPa · s · pN⁻¹] | 9.4 |

Next, the prepared LC-A was used to prepare MLC-A-1 to 3 (Comparative Examples 1 to 3) and MLC-1-1 to 9 (Examples 1-1 to 15), and injected into the test cell in vacuum, and the VHR thereof before and after the UV light irradiation was measured. The measurement results of the structure and the VHR of the liquid crystal composition are as shown in Table 2. The liquid crystal composition to which the polymerizable compound has been added is not largely different in physical property value from the liquid crystal composition to which the polymerizable compound has not been added yet.

TABLE 2

| | | Comparative | Comparative | Comparative | Example | Example | Example |
|---|---|---|---|---|---|---|---|
| | | Example 1-1 | Example 1-2 | Example 1-3 | 1-1 | 1-2 | 1-3 |
| | | MLC-A-1 | MLC-A-2 | MLC-A-3 | MLC-1-1 | MLC-1-2 | MLC-1-3 |
| LC-A | | 99.80% | 99.70% | 99.60% | 99.55% | 99.50% | 99.45% |
| Polymerizable Formula | | 0.20% | 0.30% | 0.40% | 0.45% | 0.50% | 0.55% |
| compound (Ib-3) | | | | | | | |
| Total | | 100.00% | 100.00% | 100.00% | 100.00% | 100.00% | 100.00% |
| VHR/% | Initial | 98.1 | 98.2 | 98.1 | 98.1 | 98.1 | 98.0 |
| | After | 95.2 | 96.3 | 96.8 | 97.6 | 97.7 | 97.7 |
| | UV 60J | | | | | | |
| | | Example 1-4 | Example 1-5 | Example 1-6 | Example 1-7 | Example 1-8 | Example 1-9 |
| | | MLC-1-4 | MLC-1-5 | MLC-1-6 | MLC-1-7 | MLC-1-8 | MLC-1-9 |
| LC-A | | 99.30% | 99.10% | 99.59% | 99.55% | 99.30% | 99.30% |
| Polymerizable Formula | | | | | | | 0.70% |
| compound (Ia-31) | | | | | | | |
| Polymerizable Formula | | 0.70% | 0.90% | | | | |
| compound (Ib-3) | | | | | | | |
| Polymerizable Formula | | | | 0.41% | 0.45% | 0.70% | |
| compound (Id-29) | | | | | | | |
| Total | | 100.00% | 100.00% | 100.00% | 100.00% | 100.00% | 100.00% |
| VHR/% | Initial | 98.0 | 97.8 | 98.2 | 98.1 | 98.2 | 97.7 |
| | After | 97.8 | 97.9 | 97.6 | 97.1 | 98.0 | 97.9 |
| | UV 60J | | | | | | |
| | | Example | Example | Example | Example | Example | Example |
| | | 1-10 | 1-11 | 1-12 | 1-13 | 1-14 | 1-15 |
| | | MLC-1-10 | MLC-1-11 | MLC-1-12 | MLC-1-13 | MLC-1-14 | MLC-1-15 |
| LC-A | | 99.55% | 99.50% | 99.46% | 99.50% | 99.00% | 99.10% |
| Polymerizable Formula | | 0.05% | 0.10% | | 0.15% | | 0.30% |
| compound (Ia-31) | | | | | | | |
| Polymerizable Formula | | 0.40% | 0.40% | 0.10% | 0.20% | 0.50% | 0.30% |
| compound (Ib-3) | | | | | | | |
| Polymerizable Formula | | | | 0.44% | 0.15% | 0.50% | 0.30% |
| compound (Id-29) | | | | | | | |
| Total | | 100.00% | 100.00% | 100.00% | 100.00% | 100.00% | 100.00% |
| VHR/% | Initial | 98.0 | 98.0 | 98.0 | 97.9 | 97.9 | 97.6 |
| | After | 97.5 | 97.6 | 97.5 | 97.5 | 98.1 | 98.0 |
| | UV 60J | | | | | | |

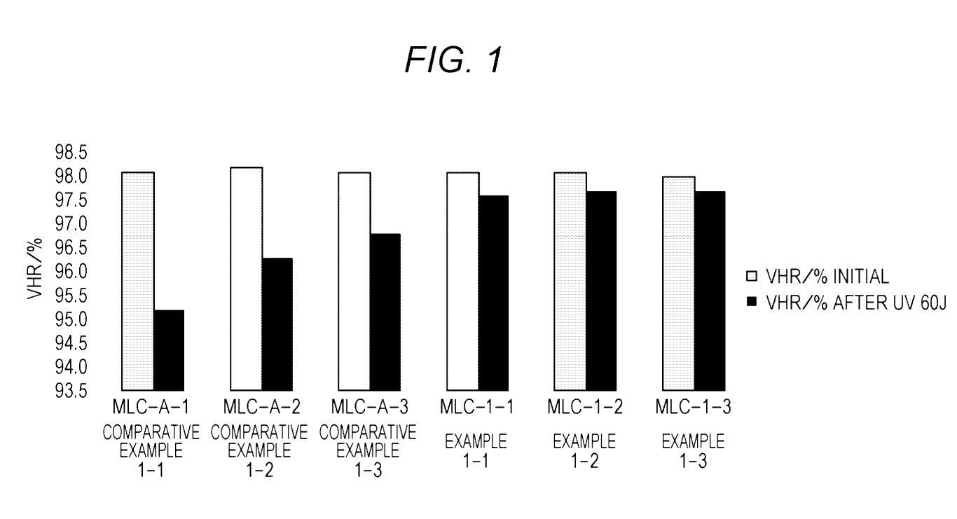

FIG. 1 is the graph of the VHR of MLC-A-1 to 3 (Comparative Examples 1 to 3) and MLC-1-1 to 3 (Examples 1-1 to 3) before and after the UV irradiation.

The VHR of MLC-1-1 to 3, which correspond to the liquid crystal composition according to the present invention, after the UV light irradiation is clearly higher than that of MLC-A-1 to 3, which correspond to the comparative examples, and MLC-1-1 to 3 exhibits the sufficient UV resistance.

In addition, it has been confirmed that the liquid crystal composition according to the present invention exhibits the high UV resistance without depending on the type of polyluerizable compound and the type of the polymerizable compound to be used in combination, like MLC-1-4 to 15 (Examples 1-4 to 15).

Thus, it has been confirmed that the liquid crystal composition according to the present invention has the sufficiently high UV resistance without deteriorating the nematic phase-isotropic liquid phase transition temperature (Tₙᵢ), the refractive index anisotropy (Δn), the dielectric anisotropy (Δ∈), the rotational viscosity (γ₁), and the elastic constant (K₃₃), and therefore can provide the liquid crystal display element of, for example, the VA mode with the excellent display quality.

### Comparative Example 2, Examples 2-1 to 3

LC-B was prepared as the matrix liquid crystal. The structures and the physical property values of the liquid crystal composition are as shown in Table 3.

TABLE 3

| | LC-B |
|---|---|
| 3-Cy—Cy-2 | 18.0% |
| 3-Cy—Cy-4 | 8.0% |
| 3-Cy—Ph—O1 | 4.0% |
| 3-Ph—Ph-1 | 11.0% |
| 3-Cy—Cy—Ph-1 | 5.0% |
| 3-Cy—1O—Ph5—O2 | 11.0% |
| 3-Cy—Ph—Ph5—O3 | 7.0% |
| 3-Cy—Ph—Ph5—O4 | 8.0% |
| 4-Cy—Ph—Ph5—O3 | 6.0% |
| 2-Cy—Cy—1O—Ph5—O2 | 6.0% |
| 3-Cy—Cy—1O—Ph5—O2 | 11.0% |
| 3-Ph—Ph5—Ph-2 | 5.0% |
| Total | 100.0% |
| Tni [° C.] | 75 |
| Tcn [° C.] | −35 |
| Δn | 0.109 |
| Δε | −3.1 |
| γ₁ [mPa · s] | 118 |
| K₃₃ [pN] | 13.0 |
| γ₁/K₃₃ [mPa · s · pN⁻¹] | 9.0 |

Next, the prepared LC-B was used to prepare MLC-B (Comparative Example 2) and MLC-2-1 to 3 (Examples 2-1 to 3), and injected into the test cell in vacuum, and the VHR thereof before and after the UV light irradiation was measured. The measurement results of the structure and the VHR of the liquid crystal composition are as shown in Table 4. The liquid crystal composition to which the polymerizable compound has been added is not largely different in physical property value from the liquid crystal composition to which the polymerizable compound has not been added yet.

TABLE 4

| | | Comparative | Example | Example | Example |
|---|---|---|---|---|---|
| | | Example 2 | 2-1 | 2-2 | 2-3 |
| | | MLC-B | MLC-2-1 | MLC-2-2 | MLC-2-3 |
| LC-B | | 99.72% | 99.58% | 99.48% | 99.18% |
| Polymerizable | Formula (Ib-3) | 0.28% | 0.42% | 0.42% | 0.42% |
| compound | | | | | |
| Polymerizable | Formula (id-29) | | | 0.10% | 0.40% |
| compound | | | | | |
| Total | | 100.00% | 100.00% | 100.00% | 100.00% |
| VHR/% | Initial | 97.9 | 97.8 | 97.9 | 97.9 |
| | After UV 60J | 95.9 | 96.9 | 97.2 | 97.4 |

The VHR of MLC-2-1 to 3, which correspond to the liquid crystal composition according to the present invention, after the UV light irradiation is higher than that of MLC-B according to Comparative Example 2.

Thus, it has been confirmed that the liquid crystal composition according to the present invention has the sufficiently high UV resistance without deteriorating the nematic phase-isotropic liquid phase transition temperature (Tₙᵢ), the refractive index anisotropy (Δn), the dielectric anisotropy (Δ∈), the rotational viscosity (γ₁), and the elastic constant (K₃₃), and therefore can provide the liquid crystal display element of, for example, the VA mode with the excellent display quality.

### Comparative Example 3, Examples 3-1 to 3

LC-C was prepared as the matrix liquid crystal. The structures and the physical property values of the liquid crystal composition are as shown in Table 5.

TABLE 5

| | LC-C |
|---|---|
| 3-Cy—Cy—V | 39.0% |
| 3-Ph—Ph-1 | 5.0% |
| 3-Cy—1O—Ph5—O2 | 9.0% |
| 2-Cy—Cy—1O—Ph5—O2 | 12.5% |
| 3-Cy—Cy—1O—Ph5—O2 | 13.0% |
| 4-Cy—Cy—1O—Ph5—O2 | 3.5% |
| 3-Ph—Ph5—Ph-1 | 9.0% |
| 3-Ph—Ph5—Ph-2 | 9.0% |
| Total | 100.0% |
| Tni [° C.] | 75 |
| Tcn [° C.] | −54 |
| Δn | 0.108 |
| Δε | −3.1 |
| γ₁ [mPa · s] | 96 |
| K₃₃ [pN] | 14.3 |
| γ₁/K₃₃ [mPa · s · pN⁻¹] | 6.7 |

Next, the prepared LC-C was used to prepare MLC-C(Comparative Example 3) and MLC-3-1 to 3 (Examples 3-1 to 3), and injected into the test cell in vacuum, and the VHR thereof before and after the UV light irradiation was measured. The measurement results of the structure and the VHR of the liquid crystal composition are as shown in Table 6. The liquid crystal composition to which the polymerizable compound has been added is not largely different in physical property value from the liquid crystal composition to which the polymerizable compound has not been added yet.

TABLE 6

| | | Comparative | Example | Example | Example |
|---|---|---|---|---|---|
| | | Example 3 | 3-1 | 3-2 | 3-3 |
| | | MLC-C | MLC-3-1 | MLC-3-2 | MLC-3-3 |
| LC-C | | 99.60% | 99.50% | 99.40% | 99.60% |
| Polymerizable | Formula (Ia-31) | | | | 0.10% |
| compound | | | | | |
| Polymerizable | Formula (Ib-1) | 0.40% | 0.50% | 0.50% | |
| compound | | | | | |
| Polymerizable | Formula (Ib-3) | | | | 0.40% |
| compound | | | | | |
| Total | | 100.00% | 100.00% | 100.00% | 100.00% |
| VHR/% | Initial | 97.9 | 97.9 | 97.8 | 97.8 |
| | After UV 60J | 93.5 | 95.0 | 95.2 | 94.7 |

The VHR of MLC-3-1 to 3, which correspond to the liquid crystal composition according to the present invention, after the UV light irradiation is clearly higher than that of MLC-C according to Comparative Example 3.

Thus, it has been confirmed that the liquid crystal composition according to the present invention has the sufficiently high UV resistance without deteriorating the nematic phase-isotropic liquid phase transition temperature (Tₙᵢ), the refractive index anisotropy (Δn), the dielectric anisotropy (Δ∈), the rotational viscosity (γ₁), and the elastic constant (K₃₃), and therefore can provide the liquid crystal display element of, for example, the VA mode with the excellent display quality.

### Comparative Example 4, Examples 4-1 to 4

LC-D was prepared as the matrix liquid crystal. The structures and the physical property values of the liquid crystal composition are as shown in Table 7.

TABLE 7

| | LC-D |
|---|---|
| 3-Cy—Cy-2 | 4.0% |
| 2-Cy—Cy—V1 | 20.0% |
| 3-Cy—Cy—V1 | 8.0% |
| 3-Ph—Ph-1 | 10.0% |
| 5-Ph—Ph-1 | 7.0% |
| 3-Cy—Ph—Ph-2 | 5.5% |
| 1V—Cy—1O—Ph5—O2 | 8.0% |
| 2-Cy—Cy—1O—Ph5—O2 | 5.5% |
| 3-Cy—Cy—1O—Ph5—O2 | 10.0% |
| V—Cy—Cy—1O—Ph5—O2 | 10.0% |
| 1V—Cy—Cy—1O—Ph5—O2 | 10.0% |
| 3-Np—Ph5—Ph-2 | 2.0% |
| Total | 100.0% |
| Tni [° C.] | 75 |
| Tcn [° C.] | −54 |
| Δn | 0.109 |
| Δε | −3.1 |
| γ₁ [mPa · s] | 114 |
| K₃₃ [pN] | 16.2 |
| γ₁/K₃₃ [mPa · s · pN⁻¹] | 7.0 |

Next, the prepared LC-D was used to prepare MLC-D (Comparative Example 4) and MLC-4-1 to 4 (Examples 4-1 to 4), and injected into the test cell in vacuum, and the VHR thereof before and after the UV light irradiation was measured. The measurement results of the structure and the VHR of the liquid crystal composition are as shown in Table 8. The liquid crystal composition to which the polymerizable compound has been added is not largely different in physical property value from the liquid crystal composition to which the polymerizable compound has not been added yet.

TABLE 8

| | | Comparative | Example | Example | Example | Example |
|---|---|---|---|---|---|---|
| | | Example 4 | 4-1 | 4-2 | 4-3 | 4-4 |
| | | MLC-D | MLC-4-1 | MLC-4-2 | MLC-4-3 | MLC-4-4 |
| LC-D | | 99.72% | 99.56% | 99.46% | 99.36% | 99.46% |
| Polymerizable | Formula (Ib-3) | | | | | 0.10% |
| compound | | | | | | |
| Polymerizable | Formula (Id-29) | 0.28% | 0.14% | 0.54% | 0.64% | 0.44% |
| compound | | | | | | |
| Total | | 100.00% | 100.00% | 100.00% | 100.00% | 100.00% |
| VHR/% | Initial | 98.0 | 97.9 | 98.0 | 97.9 | 98.0 |
| | After UV 60J | 95.6 | 96.8 | 97.5 | 97.6 | 97.3 |

The VHR of MLC-4-1 to 4, which correspond to the liquid crystal composition according to the present invention, after the UV light irradiation is clearly higher than that of MLC-D according to Comparative Example 4.

Thus, it has been confirmed that the liquid crystal composition according to the present invention has the sufficiently high UV resistance without deteriorating the nematic phase-isotropic liquid phase transition temperature (Tₙᵢ), the refractive index anisotropy (Δn), the dielectric anisotropy (Δ∈), the rotational viscosity (γ₁), and the elastic constant (K₃₃), and therefore can provide the liquid crystal display element of, for example, the VA mode with the excellent display quality.

### Comparative Example 5, Examples 5-1 to 4

LC-E was prepared as the matrix liquid crystal. The structures and the physical property values of the liquid crystal composition are as shown in Table 9.

TABLE 9

| | LC-E |
|---|---|
| 3-Cy—Cy-2 | 4.0% |
| 2-Cy—Cy—V1 | 20.0% |
| 3-Cy—Cy—V1 | 10.0% |
| 3-Ph—Ph-1 | 13.0% |
| 3-Cy—Ph—Ph-2 | 7.0% |
| 5-Cy—Ph—Ph-2 | 5.5% |
| 3-Cy—1O—Ph5—O2 | 4.5% |
| 1V-Cy—1O—Ph5—O2 | 8.0% |
| 2-Cy—Cy—1O—Ph5—O2 | 5.5% |
| 3-Cy—Cy—1O—Ph5—O2 | 11.0% |
| 1V—Cy—Cy—1O—Ph5—O2 | 9.5% |
| 3-Np—Ph5—Ph-2 | 2.0% |
| Total | 100.0% |
| Tni [° C.] | 75 |
| Tcn [° C.] | −56 |
| Δn | 0.109 |
| Δε | −2.7 |
| γ₁ [mPa · s] | 109 |
| K₃₃ [pN] | 15.7 |
| γ₁/K₃₃ [mPa · s · pN⁻¹] | 6.9 |

Next, the prepared LC-E was used to prepare MLC-E (Comparative Example 5) and MLC-5-1 to 4 (Examples 5-1 to 4), and injected into the test cell in vacuum, and the VHR thereof before and after the UV light irradiation was measured. The measurement results of the structure and the VHR of the liquid crystal composition are as shown in Table 10. The liquid crystal composition to which the polymerizable compound has been added is not largely different in physical property value from the liquid crystal composition to which the polymerizable compound has not been added yet.

TABLE 10

| | | Comparative | Example | Example | Example | Example |
|---|---|---|---|---|---|---|
| | | Example 5 | 5-1 | 5-2 | 5-3 | 5-4 |
| | | MLC-E | MLC-5-1 | MLC-5-2 | MLC-5-3 | MLC-5-4 |
| LC-E | | 99.66% | 99.56% | 99.46% | 99.36% | 99.46% |
| Polymerizable | Formula (Ib-3) | | | | | 0.10% |
| compound | | | | | | |
| Polymerizable | Formula (Id-29) | 0.34% | 0.44% | 0.54% | 0.64% | 0.44% |
| compound | | | | | | |
| Total | | 100.00% | 100.00% | 100.00% | 100.00% | 100.00% |
| VHR/% | Initial | 98.5 | 98.4 | 98.5 | 98.4 | 98.5 |
| | After UV 60J | 96.2 | 97.5 | 98.0 | 98.1 | 97.9 |

The VHR of MLC-5-1 to 4, which correspond to the liquid crystal composition according to the present invention, after the UV light irradiation is clearly higher than that of MLC-E according to Comparative Example 5.

Thus, it has been confirmed that the liquid crystal composition according to the present invention has the sufficiently high UV resistance without deteriorating the nematic phase-isotropic liquid phase transition temperature (Tₙᵢ), the refractive index anisotropy (Δn), the dielectric anisotropy (Δ∈), the rotational viscosity (γ₁), and the elastic constant (K₃₃), and therefore can provide the liquid crystal display element of, for example, the VA mode with the excellent display quality.

### Comparative Example 6, Examples 6-1 to 4

LC-F was prepared as the matrix liquid crystal. The structures and the physical property values of the liquid crystal composition are as shown in Table 11.

TABLE 11

| | LC-F |
|---|---|
| 3-Cy—Cy-2 | 29.0% |
| 3-Cy—Cy-4 | 8.0% |
| 3-Ph—Ph-1 | 9.5% |
| 1V—Cy—Ph—Ph-3 | 4.0% |
| 1V—Cy—1O—Ph5—O2 | 14.0% |
| 3-Cy—Ph—Ph5—O2 | 16.5% |
| 1V—Cy—Cy—1O—Ph5—O2 | 16.0% |
| 3-Np—Ph5—Ph-2 | 3.0% |
| Total | 100.0% |
| Tni [° C.] | 77 |
| Tcn [° C.] | −5 |
| Δn | 0.109 |
| Δε | −3.1 |
| γ₁ [mPa · s] | 112 |
| K₃₃ [pN] | 15.9 |
| γ₁/K₃₃ [mPa · s · pN⁻¹] | 7.0 |

Next, the prepared LC-F was used to prepare MLC-F (Comparative Example 6) and MLC-6-1 to 4 (Examples 6-1 to 4), and injected into the test cell in vacuum, and the VHR thereof before and after the UV light irradiation was measured. The measurement results of the structure and the VHR of the liquid crystal composition are as shown in Table 12. The liquid crystal composition to which the polymerizable compound has been added is not largely different in physical property value from the liquid crystal composition to which the polymerizable compound has not been added yet.

TABLE 12

| | | Comparative | Example | Example | Example | Example |
|---|---|---|---|---|---|---|
| | | Example 6 | 6-1 | 6-2 | 6-3 | 6-4 |
| | | MCL-F | MCL-6-1 | MCL-6-2 | MCL-6-3 | MCL-6-4 |
| LC-F | | 99.66% | 99.56% | 99.46% | 99.36% | 99.46% |
| Polymerizable | Formula (Ib-3) | | | | | 0.10% |
| compound | | | | | | |
| Polymerizable | Formula (Id-29) | 0.34% | 0.44% | 0.54% | 0.64% | 0.44% |
| compound | | | | | | |
| Total | | 100.00% | 100.00% | 100.00% | 100.00% | 100.00% |
| VHR% | Initial | 98.2 | 98.1 | 98.1 | 98.2 | 98.2 |
| | After UV 60J | 96.9 | 97.5 | 97.8 | 97.9 | 97.6 |

The VHR of MLC-6-1 to 4, which correspond to the liquid crystal composition according to the present invention, after the UV light irradiation is clearly higher than that of MLC-F according to Comparative Example 6.

Thus, it has been confirmed that the liquid crystal composition according to the present invention has the sufficiently high UV resistance without deteriorating the nematic phase-isotropic liquid phase transition temperature (Tₙᵢ), the refractive index anisotropy (Δn), the dielectric anisotropy (Δ∈), the rotational viscosity (γ₁), and the elastic constant (K₃₃), and therefore can provide the liquid crystal display element of, for example, the VA mode with the excellent display quality.

### Comparative Example 7, Examples 7-1 to 4

LC-G was prepared as the matrix liquid crystal. The structures and the physical property values of the liquid crystal composition are as shown in Table 13.

TABLE 13

| | LC-G |
|---|---|
| 3-Cy—Cy-2 | 24.0% |
| 3-Cy—Cy-4 | 11.0% |
| 3-Cy—Ph—O1 | 8.0% |
| 3-Cy—Ph5—O2 | 13.0% |
| 3-Cy—Cy—Ph5—O3 | 8.0% |
| 4-Cy—Cy—Ph5—O2 | 9.5% |
| 2-Cy—Ph—Ph5—O2 | 5.0% |
| 3-Cy—Ph—Ph5—O2 | 9.5% |
| 3-Ph—Ph5—Ph-2 | 12.0% |
| Total | 100.0% |
| Tni [° C.] | 76 |
| Tcn [° C.] | −23 |
| Δn | 0.102 |
| Δε | −2.8 |
| γ₁ [mPa · s] | 114 |
| K₃₃ [pN] | 13.6 |
| γ₁/K₃₃ [mPa · s · pN⁻¹] | 8.4 |

Next, the prepared LC-G was used to prepare MLC-G (Comparative Example 7) and MLC-7-1 to 4 (Examples 7-1 to 4), and injected into the test cell in vacuum, and the VHR thereof before and after the UV light irradiation was measured. The measurement results of the structure and the VHR of the liquid crystal composition are as shown in Table 14. The liquid crystal composition to which the polymerizable compound has been added is not largely different in physical property value from the liquid crystal composition to which the polymerizable compound has not been added yet.

TABLE 14

| | | Comparative | Example | Example | Example | Example |
|---|---|---|---|---|---|---|
| | | Example 7 | 7-1 | 7-2 | 7-3 | 7-4 |
| | | MLC-G | MLC-7-1 | MLC-7-2 | MLC-7-3 | MLC-7-4 |
| LC-G | | 99.80% | 99.55% | 99.40% | 99.55% | 99.70% |
| Polymerizable | Formula (Ib-3) | 0.20% | 0.45% | 0.60% | 0.40% | 0.40% |
| compound | | | | | | |
| Polymerizable | Formula (Id-29) | | | | | |
| compound | | | | | 0.05% | 0.40% |
| Total | | 100.00% | 100.00% | 100.00% | 100.00% | 100.00% |
| VHR/% | Initial | 98.4 | 98.4 | 98.3 | 98.4 | 98.4 |
| | After UV 60J | 97.0 | 97.9 | 98.2 | 98.1 | 98.3 |

The VHR of MLC-7-1 to 4, which correspond to the liquid crystal composition according to the present invention, after the UV light irradiation is clearly higher than that of MLC-G according to Comparative Example 7.

Thus, it has been confirmed that the liquid crystal composition according to the present invention has the sufficiently high UV resistance without deteriorating the nematic phase-isotropic liquid phase transition temperature (Tₙᵢ), the refractive index anisotropy (Δn), the dielectric anisotropy (Δ∈), the rotational viscosity (γ₁), and the elastic constant (K₃₃), and therefore can provide the liquid crystal display element of, for example, the VA mode with the excellent display quality.

### Comparative Example 8, Examples 8-1 to 4

LC-H was prepared as the matrix liquid crystal. The structures and the physical property values of the liquid crystal composition are as shown in Table 15.

TABLE 15

| | LC-H |
|---|---|
| 3-Cy—Cy-2 | 24.0% |
| 3-Cy—Cy-4 | 10.0% |
| 3-Cy—Ph—O1 | 7.0% |
| 3-Cy—Ph5—O2 | 13.0% |
| 4-Cy—Cy—Ph5—O2 | 9.0% |
| 5-Cy—Cy—Ph5—O2 | 5.0% |
| 2-Cy—Ph—Ph5—O2 | 8.5% |
| 3-Cy—Ph—Ph5—O2 | 8.5% |
| 3-Ph—Ph5—Ph-2 | 7.0% |
| 4-Ph—Ph5—Ph-2 | 8.0% |
| Total | 100.0% |
| Tni [° C.] | 76 |
| Tcn [° C.] | −28 |
| Δn | 0.108 |
| Δε | −2.8 |
| γ₁ [mPa · s] | 112 |
| K₃₃ [pN] | 13.7 |
| γ₁/K₃₃ [mPa · s · pN⁻¹] | 8.2 |

Next, the prepared LC-H was used to prepare MLC-H (Comparative Example 8) and MLC-8-1 to 4 (Examples 8-1 to 4), and injected into the test cell in vacuum, and the VHR thereof before and after the UV light irradiation was measured. The measurement results of the structure and the VHR of the liquid crystal composition are as shown in Table 16. The liquid crystal composition to which the polymerizable compound has been added is not largely different in physical property value from the liquid crystal composition to which the polymerizable compound has not been added yet.

TABLE 16

| | | Comparative | Example | Example | Example | Example |
|---|---|---|---|---|---|---|
| | | Example 8 | 8-1 | 8-2 | 8-3 | 8-4 |
| | | MLC-H | MLC-8-1 | MLC-8-2 | MLC-8-3 | MLC-8-4 |
| LC-H | | 99.80% | 99.58% | 99.38% | 99.38% | 99.38% |
| Polymerizable | Formula (Ib-1) | 0.20% | 0.42% | 0.62% | 0.42% | |
| compound | | | | | | |
| Polymerizable | Formula (Id-29) | | | | 0.20% | 0.62% |
| compound | | | | | | |
| Total | | 100.00% | 100.00% | 100.00% | 100.00% | 100.00% |
| VHR/% | Initial | 98.3 | 98.4 | 98.4 | 98.4 | 98.4 |
| | After UV 60J | 96.5 | 97.8 | 98.1 | 98.0 | 98.1 |

The VHR of MLC-8-1 to 4, which correspond to the liquid crystal composition according to the present invention, after the UV light irradiation is clearly higher than that of MLC-H according to Comparative Example 8.

Thus, it has been confirmed that the liquid crystal composition according to the present invention has the sufficiently high UV resistance without deteriorating the nematic phase-isotropic liquid phase transition temperature (Tₙᵢ), the refractive index anisotropy (Δn), the dielectric anisotropy (Δ∈), the rotational viscosity (γ₁), and the elastic constant (K₃₃), and therefore can provide the liquid crystal display element of, for example, the VA mode with the excellent display quality.

### Comparative Example 9, Examples 9-1 to 4

LC-I was prepared as the matrix liquid crystal. The structures and the physical property values of the liquid crystal composition are as shown in Table 17.

TABLE 17

| | LC-I |
|---|---|
| 3-Cy—Cy—V | 32.0% |
| 3-Cy—Cy—V1 | 11.0% |
| 3-Cy—Ph5—O2 | 13.0% |
| 5-Cy—Ph5—O2 | 6.0% |
| 3-Cy—Cy—Ph5—O2 | 10.0% |
| 2-Cy—Ph—Ph5—O2 | 5.0% |
| 3-Cy—Ph—Ph5—O2 | 10.0% |
| 3-Ph—Ph5—Ph-2 | 12.5% |
| 3-Ph—Ph—Ph1—Ph3—F | 0.5% |
| Total | 100.0% |
| Tni [° C.] | 76 |
| Tcn [° C.] | −25 |
| Δn | 0.108 |
| Δε | −2.7 |
| γ₁ [mPa · s] | 94 |
| K₃₃ [pN] | 14.0 |
| γ₁/K₃₃ [mPa · s · pN⁻¹] | 6.7 |

Next, the prepared LC-I was used to prepare MLC-I (Comparative Example 9) and MLC-9-1 to 4 (Examples 9-1 to 4), and injected into the test cell in vacuum, and the VHR thereof before and after the UV light irradiation was measured. The measurement results of the structure and the VHR of the liquid crystal composition are as shown in Table 18. The liquid crystal composition to which the polymerizable compound has been added is not largely different in physical property value from the liquid crystal composition to which the polymerizable compound has not been added yet.

TABLE 18

| | | Comparative | Example | Example | Example | Example |
|---|---|---|---|---|---|---|
| | | Example 9 | 9-1 | 9-2 | 9-3 | 9-4 |
| | | MLC-I | MLC-9-1 | MLC-9-2 | MLC-9-3 | MLC-9-4 |
| LC-I | | 99.66% | 99.56% | 99.46% | 99.56% | 99.46% |
| Polymerizable | Formula (Ib-1) | 0.34% | 0.44% | 0.54% | | 0.10% |
| compound | | | | | | |
| Polymerizable | Formula (Id-29) | | | | 0.44% | 0.44% |
| compound | | | | | | |
| Total | | 100.00% | 100.00% | 100.00% | 100.00% | 100.00% |
| VHR/% | Initial | 98.4 | 98.3 | 98.2 | 98.4 | 98.3 |
| | After UV 60J | 96.2 | 96.8 | 97.2 | 97.2 | 97.5 |

The VHR of MLC-9-1 to 4, which correspond to the liquid crystal composition according to the present invention, after the UV light irradiation is clearly higher than that of MLC-I according to Comparative Example 9.

Thus, it has been confirmed that the liquid crystal composition according to the present invention has the sufficiently high UV resistance without deteriorating the nematic phase-isotropic liquid phase transition temperature (Tₙᵢ), the refractive index anisotropy (Δn), the dielectric anisotropy (Δ∈), the rotational viscosity (γ₁), and the elastic constant (K₃₃), and therefore can provide the liquid crystal display element of, for example, the VA mode with the excellent display quality.

### Comparative Example 10, Examples 10-1 to 4

LC-J was prepared as the matrix liquid crystal. The structures and the physical property values of the liquid crystal composition are as shown in Table 19.

TABLE 19

| | LC-J |
|---|---|
| 3-Cy—Cy—V | 37.0% |
| 3-Cy—Cy—V1 | 2.0% |
| 3-Cy—Cy—Ph1—F | 12.0% |
| 5-Cy—Cy—Ph1—F | 12.0% |
| 3-Ph1—Np3—F | 9.0% |
| 2-Cy—Ph1—Np3—F | 6.0% |
| 3-Cy—Ph1—Np3—F | 13.0% |
| 2-Ph—Ph1—Np3—F | 4.0% |
| 2-Cy-2-Cy—Cy—Ph1—F | 5.0% |
| Total | 100.0% |
| Tni [° C.] | 76 |
| Tcn [° C.] | −70 |
| Δn | 0.105 |
| Δε | 7.0 |
| γ₁ [mPa · s] | 81 |

Next, the prepared LC-J was used to prepare MLC-J (Comparative Example 10) and MLC-10-1 to 4 (Examples 10-1 to 4), and injected into the test cell in vacuum, and the VHR thereof before and after the UV light irradiation was measured. The measurement results of the structure and the VHR of the liquid crystal composition are as shown in Table 20. The liquid crystal composition to which the polymerizable compound has been added is not largely different in physical property value from the liquid crystal composition to which the polymerizable compound has not been added yet.

TABLE 20

| | | Comparative | Example | Example | Example | Example |
|---|---|---|---|---|---|---|
| | | Example 10 | 10-1 | 10-2 | 10-3 | 10-4 |
| | | MLC-J | MLC-10-1 | MLC-10-2 | MLC-10-3 | MLC-10-4 |
| LC-J | | 99.70% | 99.50% | 99.50% | 99.50% | 99.50% |
| Polymerizable | Formula (Ia-31) | | | | 0.10 | |
| comprsund | | | | | | |
| Polymerizable | Formula (Ib-1) | 0.30% | 0.50% | | | |
| compound | | | | | | |
| Polymerizable | Formula (Ib-3) | | | 0.50% | 0.40% | |
| compound | | | | | | |
| Polymerizable | Formula (Id-29) | | | | | 0.50% |
| compound | | | | | | |
| Total | | 100.00% | 100.00% | 100.00% | 100.00% | 100.00% |
| VHR/% | Initial | 98.8 | 98.7 | 98.7 | 98.6 | 98.8 |
| | After UV 60J | 97.8 | 98.2 | 98.2 | 98.1 | 98.4 |

The VHR of MLC-10-1 to 4, which correspond to the liquid crystal composition according to the present invention, after the UV light irradiation is clearly higher than that of MLC-J according to Comparative Example 10.

Thus, it has been confirmed that the liquid crystal composition according to the present invention has the sufficiently high UV resistance without deteriorating the nematic phase-isotropic liquid phase transition temperature (Tₙᵢ), the refractive index anisotropy (Δn), the dielectric anisotropy (ΔΣ), and the rotational viscosity (γ₁), and therefore can provide the liquid crystal display element of, for example, the TN, IPS, or FFS mode with the excellent display quality.

### Comparative Example 11, Examples 11-1 to 4

LC-K was prepared as the matrix liquid crystal. The structures and the physical property values of the liquid crystal composition are as shown in Table 21.

TABLE 21

| | LC-K |
|---|---|
| 3-Cy—Cy—V | 46.0% |
| V2—Cy—Cy—Ph-1 | 6.0% |
| V—Cy—Ph—Ph-3 | 3.0% |
| 3-Cy—Cy—Ph1—F | 7.0% |
| 2-Ph3—O1—Cy—Ph3—Ph3—F | 5.0% |
| 3-Ph3—O1—Cy—Ph3—Ph3—F | 4.0% |
| 3-Ph—Ph3—CF2O—Np3—F | 11.0% |
| 3-Ph—Ph1—Ph3—CF2O—Np3—F | 6.0% |
| 4-Ph—Ph1—Ph3—CF2O—Np3—F | 4.0% |
| 3-Ph3—O1—Ph—Np3—F | 8.0% |
| Total | 100.0% |
| Tni [° C.] | 79 |
| Tcn [° C.] | −35 |
| Δn | 0.109 |
| Δε | 11.8 |
| γ₁ [mPa · s] | 63 |

Next, the prepared LC-K was used to prepare MLC-K (Comparative Example 11) and MLC-11-1 to 4 (Examples 11-1 to 4), and injected into the test cell in vacuum, and the VHR thereof before and after the UV light irradiation was measured. The measurement results of the structure and the VHR of the liquid crystal composition are as shown in Table 22. The liquid crystal composition to which the polymerizable compound has been added is not largely different in physical property value from the liquid crystal composition to which the polymerizable compound has not been added yet.

TABLE 22

| | | Comparative | Example | Example | Example | Example |
|---|---|---|---|---|---|---|
| | | Example 11 | 11-1 | 11-2 | 11-3 | 11-4 |
| | | MLC-K | MLC-11-1 | MLC-11-2 | MLC-11-3 | MLC-11-4 |
| LC-K | | 99.70% | 99.50% | 99.50% | 99.50% | 99.50% |
| Polymerizable | Formula (Ia-31) | | | | 0.10% | |
| compound | | | | | | |
| Polymerizable | Formula (Ib-1) | 0.30% | 0.50% | | | |
| compound | | | | | | |
| Polymerizable | Formula (Ib-3) | | | | | |
| compound | | | | 0.50% | 0.40% | |
| Polymerizable | Formula (Id-29) | | | | | 0.50% |
| compound | | | | | | |
| Total | | 100.00% | 100.00% | 100.00% | 100.00% | 100.00% |
| VHR/% | Initial | 98.9 | 99.0 | 98.9 | 98.9 | 99.0 |
| | After UV 60J | 98.1 | 98.5 | 98.4 | 98.4 | 98.5 |

The VHR of MLC-11-1 to 4, which correspond to the liquid crystal composition according to the present invention, after the UV light irradiation is clearly higher than that of MLC-K according to Comparative Example 11.

Thus, it has been confirmed that the liquid crystal composition according to the present invention has the sufficiently high UV resistance without deteriorating the nematic phase-isotropic liquid phase transition temperature (Tₙᵢ), the refractive index anisotropy (Δn), the dielectric anisotropy (Δ∈), and the rotational viscosity (γ₁), and therefore can provide the liquid crystal display element of, for example, the TN, IPS, or FFS mode with the excellent display quality.

### Comparative Example 12, Examples 12-1 to 4

LC-L was prepared as the matrix liquid crystal. The structures and the physical property values of the liquid crystal composition are as shown in Table 23.

TABLE 23

| | LC-L |
|---|---|
| 3-Cy—Cy—V | 35.0% |
| 3-Cy—Cy—V1 | 10.0% |
| 1-Ph—Ph—2V1 | 6.0% |
| V2—Ph—Ph1—Ph-2 | 9.0% |
| 3-Ph—Ph3—CF2O—Ph3—F | 10.0% |
| 3-Ph—Ph1—Ph3—CF2O—Ph3—F | 5.0% |
| 4-Ph—Ph1—Ph3—CF2O—Ph3—F | 7.0% |
| 5-Ph—Ph1—Ph3—CF2O—Ph3—F | 5.0% |
| 2-Py—Ph—Ph3—CF2O—Ph3—F | 6.0% |
| 3-Py—Ph—Ph3—CF2O—Ph3—F | 7.0% |
| Total | 100.0% |
| Tni [° C.] | 76 |
| Tcn [° C.] | −45 |
| Δn | 0.123 |
| Δε | 11.3 |
| γ₁ [mPa · s] | 73 |

Next, the prepared LC-L was used to prepare MLC-L (Comparative Example 12) and MLC-12-1 to 4 (Examples 12-1 to 4), and injected into the test cell in vacuum, and the VHR thereof before and after the UV light irradiation was measured. The measurement results of the structure and the VHR of the liquid crystal composition are as shown in Table 24. The liquid crystal composition to which the polymerizable compound has been added is not largely different in physical property value from the liquid crystal composition to which the polymerizable compound has not been added yet.

TABLE 24

| | | Comparatve | Example | Example | Example | Example |
|---|---|---|---|---|---|---|
| | | Example 12 | 12-1 | 12-2 | 12-3 | 12-4 |
| | | MLC-L | MLC-12-1 | MLC-12-2 | MLC-12-3 | MLC-12-4 |
| LC-L | | 99.70% | 99.50% | 99.50% | 99.50% | 99.50% |
| Polymerizable | Formula (Ia-31) | | | | 0.10% | |
| compound | | | | | | |
| Polymerizable | Formula (Ib-1) | 0.30% | 0.50% | | | |
| compound | | | | | | |
| Polymerizable | Formula (Ib-3) | | | 0.50% | 0.40% | |
| compound | | | | | | |
| Polymerizable | Formula (Id-29) | | | | | 0.50% |
| compound | | | | | | |
| Total | | 100.00% | 100.00% | 100.00% | 100.00% | 100.00% |
| VHR/% | Initial | 98.9 | 98.9 | 99.0 | 98.9 | 98.9 |
| | After UV 60J | 97.9 | 98.5 | 98.4 | 98.5 | 98.5 |

The VHR of MLC-12-1 to 4, which correspond to the liquid crystal composition according to the present invention, after the UV light irradiation is clearly higher than that of MLC-L according to Comparative Example 12.

Thus, it has been confirmed that the liquid crystal composition according to the present invention has the sufficiently high UV resistance without deteriorating the nematic phase-isotropic liquid phase transition temperature (T_{Ni}), the refractive index anisotropy (Δn), the dielectric anisotropy (Δ∈), and the rotational viscosity (γ₁), and therefore can provide the liquid crystal display element of, for example, the TN, IPS, or FFS mode with the excellent display quality.

1. A polymerizable compound containing liquid crystal composition comprising a polymerizable compound and a liquid crystal compound, the polymerizable compound being contained by 0.41 mass % or more and 10.0 mass % or less in total, wherein
as the polymerizable compound, one kind or two or more kinds of compounds represented by a general formula (1) are contained: 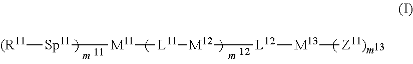
(in the general formula (1), Z¹¹ represents a fluorine atom, a cyano group, a hydrogen atom, an alkyl group with 1 to 15 carbon atoms whose hydrogen atom may be substituted with a halogen atom, an alkoxy group with 1 to 15 carbon atoms whose hydrogen atom may be substituted with a halogen atom, an alkenyl group with 1 to 15 carbon atoms whose hydrogen atom may be substituted with a halogen atom, an alkenyloxy group with 1 to 15 carbon atoms whose hydrogen atom may be substituted with a halogen atom, or -Sp¹²-R¹,
R¹¹ and R¹² independently represent any of the following formulae (R-1) to (R-15): 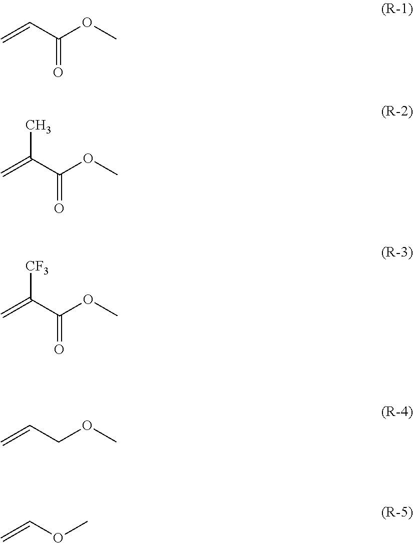 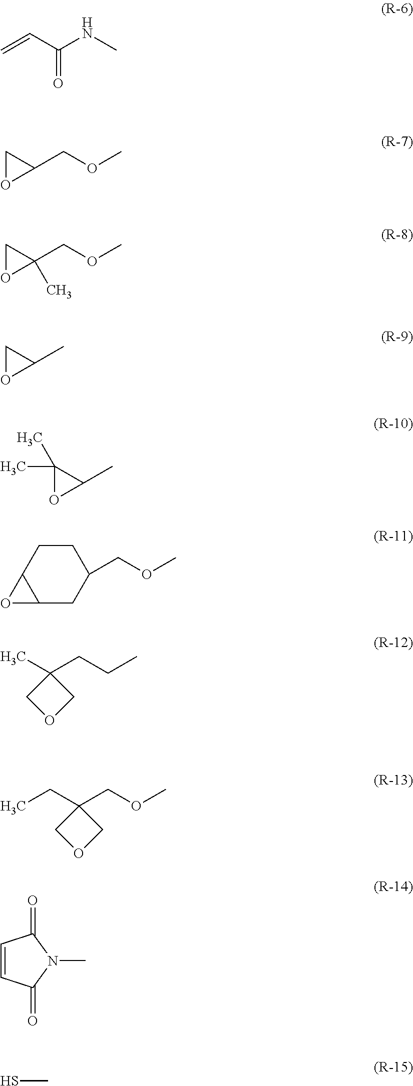
Sp¹¹ and Sp¹² represent a spacer group,
L¹¹ and L¹² independently represent a single bond, —O—, —S—, —CH₂—, —OCH₂—, —CH₂O—, —CO—, —C₂H₄—, —COO—, —OCO—, —OCOOCH₂—, —CH₂OCOO—, —OCH₂CH₂O—, —CO—NR^{a}—, —NR^{a}—CO—, —SCH₂—, —CH₂S—, —CH═CR^{a}—COO—, —CH═CR^{a}—OCO—, —COO—CR^{a}═CH—, —OCO—CR^{a}═CH—, —COO—CR^{a}═CH—COO—, —COO—CR^{a}═CH—OCO—, —OCO—CR^{a}═CH—COO—, —OCO—CR^{a}═CH—OCO—, —(CH₂)_{z}—C(═O)—O—, —(CH₂)z-O—(C═O)—, —O—(C═O)—(CH₂)z-, —(C═O)—O—(CH₂)z-, —CH═CH—, —CF═CF—, —CF═CH—, —CH═CF—, —CF₂—, —CF₂O—, —OCF₂—, —CF₂CH₂—, —CH₂CF₂—, —CF₂CF₂—, or —C≡C— (in the formula, R^{a} independently represents a hydrogen atom or an alkyl group with 1 to 4 carbon atoms, and in the formula, z represents an integer of 1 to 4),
M¹² represents a 1,4-phenylene group, a 1,4-cyclohexylene group, an anthracene-2,6-diyl group, a phenanthrene-2,7-diyl group, a pyridine-2,5-diyl group, a pyrimidine-2,5-diyl group, a naphthalene-2,6-diyl group, an indane-2,5-diyl group, a 1,2,3,4-tetrahydronaphthalene-2,6-diyl group, or a 1,3-dioxane-2,5-diyl group, and M¹² may be non-substituted or be substituted with an alkyl group with 1 to 12 carbon atoms, a halogenated alkyl group with 1 to 12 carbon atoms, an alkoxy group with 1 to 12 carbon atoms, a halogenated alkoxy group with 1 to 12 carbon atoms, a halogen atom, a cyano group, a nitro group, or —R¹¹,
M¹¹ represents any of the following formulae (i-11) to (ix-11): 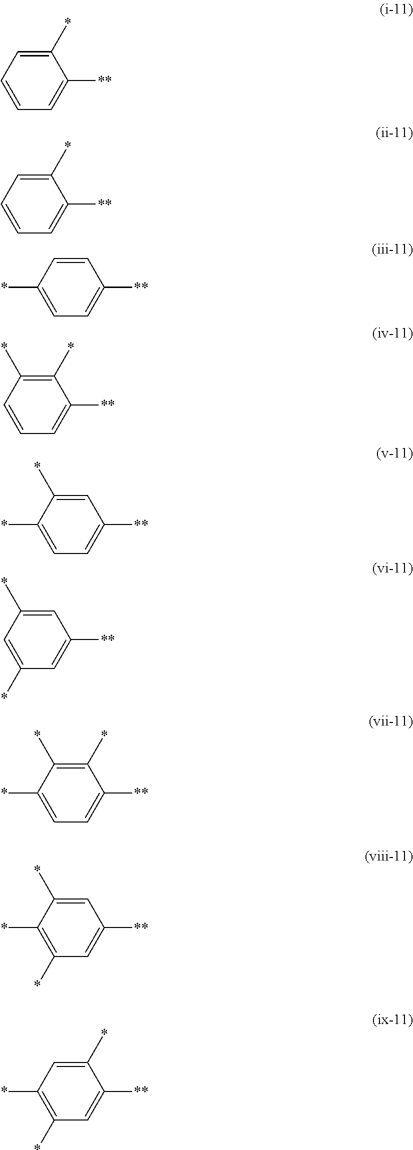
(in the formula, the compound is bonded to Sp¹¹ at ★, and to L¹¹ or L¹² at ★ ★),
M¹³ represents any of the following formulae (i-13) to (ix-13): 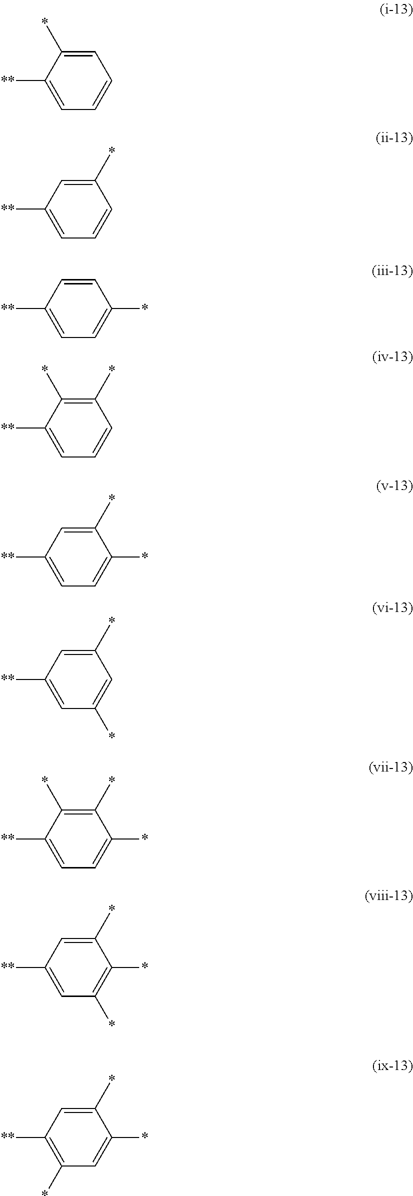
(in the formula, the compound is bonded to Z¹¹ at ★ and to L¹² at ★ ★),
m¹² represents 0, 1, 2, or 3, m¹¹ and m¹³ independently represent 1, 2, or 3, and when there is a plurality of Z¹¹, the plurality of Z¹¹ is either the same or different, when there is a plurality of R¹¹, the plurality of R¹¹ is either the same or different, when there is a plurality of R¹², the plurality of R¹² is either the same or different, when there is a plurality of Sp¹¹, the plurality of Sp¹¹ is either the same or different, when there is a plurality of Sp¹², the plurality of Sp¹² is either the same or different, when there is a plurality of L¹¹, the plurality of L¹¹ is either the same or different, and when there is a plurality of M¹², the plurality of M¹² is either the same or different); and
as the liquid crystal compound, one kind or two or more kinds of compounds represented by a general formula (LC) are contained: 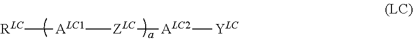
(in the general formula (LC), R^{LC} represents an alkyl group with 1 to 15 carbon atoms, one or two or more CH₂ groups in the alkyl group may be substituted with —O—, —CH═CH—, —CO—, —OCO—, —COO—, or —C≡C— so that the oxygen atom is not adjacent directly, and one or two or more hydrogen atoms in the alkyl group may be substituted with a halogen atom arbitrarily,
A^{LC1} and A^{LC2} independently represent a group selected from:
(a) a trans-1,4-cyclohexylene group (one CH₂ group or two or more non-adjacent CH₂ groups in this trans-1,4-cyclohexylene group may be substituted with an oxygen atom or a sulfur atom);
(b) a 1,4-phenylene group (one CH group or two or more non-adjacent CH groups in this 1,4-phenylene group may be substituted with a nitrogen atom); and
(c) a 1,4-bicyclo(2.2.2)octylene group, a naphthalene-2,6-diyl group, a decahydronaphthalene-2,6-diyl group, a 1,2,3,4-tetrahydronaphthalene-2,6-diyl group, and a chroman-2,6-diyl group, and one or two or more hydrogen atoms included in the group (a), the group (b), and the group (c) may be substituted with F, Cl, CF₃, or OCF₃,
Z^{LC} represents a single bond, —CH═CH—, —CF═CF—, —C≡C—, —CH₂CH₂—, —(CH₂)₄—, —OCH₂—, —CH₂O—, —OCF₂—, —CF₂O—, —COO—, or —OCO—,
Y^{LC} represents a hydrogen atom, a fluorine atom, a chlorine atom, a cyano group, or an alkyl group with 1 to 15 carbon atoms, and one or two or more CH₂ groups in the alkyl group may be substituted with —O—, —CH═CH—, —CO—, —OCO—, —COO—, —C≡C—, —CF₂O—, or —OCF₂— so that an oxygen atom is not directly adjacent, and one or two or more hydrogen atoms in the alkyl group may be substituted with a halogen atom arbitrarily, and
“a” represents an integer of 1 to 4, and when “a” represents 2, 3, or 4 and there is a plurality of A^{LC1}, the plurality of A^{LC1} is either the same or different, and when there is a plurality of Z^{LC}, the plurality of Z^{LC} is either the same or different).

2. The polymerizable compound containing liquid crystal composition according to claim 1, wherein as the compound represented by the general formula (LC), one kind or two or more kinds of compounds selected from the compounds represented by the following general formulae (LC1) and (LC2) are further contained: 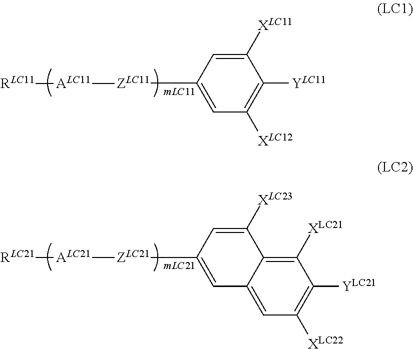
(in the formula, R^{LC11} and R^{LC21} independently represent an alkyl group with 1 to 15 carbon atoms, and one or two or more CH₂ groups in the alkyl group may be substituted with —O—, —CH═CH—, —CO—, —OCO—, —COO—, or —C≡C—, so that an oxygen atom is not directly adjacent, and one or two or more hydrogen atoms in the alkyl group may be substituted with a halogen atom arbitrarily, and A^{LC11} and A^{LC21} independently represent any of the following structures: 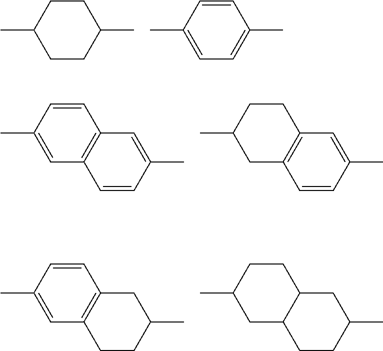
(in the structure, one or two or more CH₂ groups in the cyclohexylene group may be substituted with an oxygen atom, one or two or more CH groups in the 1,4-phenylene group may be substituted with a nitrogen atom, and one or two or more hydrogen atoms in the structure may be substituted with F, Cl, CF₃, or OCF₃), X^{LC11}, X^{LC12}, and X^{LC21} to X^{LC23} independently represent a hydrogen atom, F, Cl, CF₃, or OCF₃, Y^{LC11} and Y^{LC21} independently represent a hydrogen atom, Cl, F, CN, CF₃, OCH₂F, OCHF₂, or OCF₃, Z^{LC11} and Z^{LC12} independently represent a single bond, —CH═CH—, —CF═CF—, —C≡C—, —CH₂CH₂—, —(CH₂)₄—, —OCH₂—, —CH₂O—, —OCF₂—, —CF₂O—, —COO—, or —OCO—, m^{LC11} and m^{LC21} independently represent an integer of 1 to 4, and when there is a plurality of A^{LC11}, A^{LC21}, Z^{LC11}, and Z^{LC21}, the plurality of A^{LC11}, A^{LC21}, Z^{LC11}, and Z^{LC21} is either the same or different).

3. The polymerizable compound containing liquid crystal composition according to claim 1, wherein as the compound represented by the general formula (LC), one kind or two or more kinds of compounds selected from the compounds represented by the following general formulae (LC3) to (LC5) are further contained: 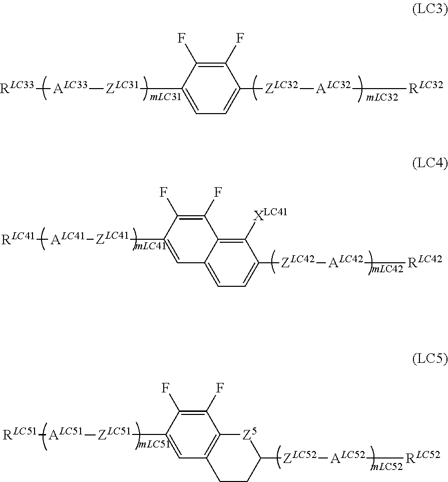
(in the formula, R^{LC31}, R^{LC32}, R^{LC41}, R^{LC42}, R^{LC51} and R^{LC52} independently represent an alkyl group with 1 to 15 carbon atoms, and one or two or more CH₂ groups in the alkyl group may be substituted with —O—, —CH═CH—, —CO—, —OCO—, —COO—, or —C═C— so that an oxygen atom is not directly adjacent, and one or two or more hydrogen atoms in the alkyl group may be substituted with a halogen atom arbitrarily, and A^{LC31}, A^{LC32}, A^{LC41}, A^{LC42}, A^{LC51} and A^{LC52} represent independently any of the following structures: 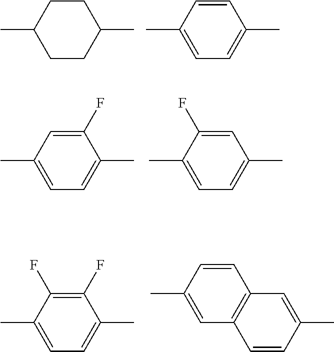
(in this structure, one or two or more CH₂ groups in the cyclohexylene group may be substituted with an oxygen atom, one or two or more CH groups in the 1,4-phenylene group may be substituted with a nitrogen atom, and one or two or more hydrogen atoms in the structure may be substituted with Cl, CF₃, or OCF₃), Z^{LC31}, Z^{LC32}, Z^{LC41}, Z^{LC42}, Z^{LC51}, and Z^{LC51} independently represent a single bond, —CH═CH—, —C≡C—, —CH₂CH₂—, —(CH₂)₄—, —COO—, —OCH₂—, —CH₂O—, —OCF₂—, or —CF₂O—, Z⁵ represents a CH₂ group or an oxygen atom, X^{LC41} represents a hydrogen atom or a fluorine atom, m^{LC31}, m^{LC32}, m^{LC41}, m^{LC42}, m^{LC51}, and m^{LC52} independently represent 0 to 3, m^{LC31}+m^{LC32}, m^{LC41}+m^{LC42}, and m^{LC51}+m^{LC52} represent 1, 2, or 3, and when there is a plurality of A^{LC31} to A^{LC52} and Z^{LC31} to Z^{LC52}, the plurality of A^{LC31} to A^{LC52} and Z^{LC31} to Z^{LC52} is either the same or different).

4. The polymerizable compound containing liquid crystal composition according to claim 1, further comprising one kind or two or more kinds of compounds selected from a compound group represented by a liquid crystal composition containing one kind or two or more kinds of compounds represented by the following general formula (LC6): 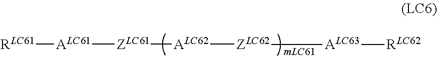
(in the formula, R^{LC61} and R^{LC62} independently represent an alkyl group with 1 to 15 carbon atoms, one or two or more CH₂ groups in the alkyl group may be substituted with —O—, —CH═CH—, —CO—, —OCO—, —COO—, or —C≡C— so that an oxygen atom is not directly adjacent, one or two or more hydrogen atoms in the alkyl group may be arbitrarily substituted with a halogen, and A^{LC62} to A^{LC63} represent independently any of the following: 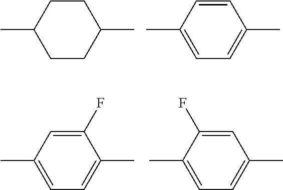
(in the structure, one or two or more CH₂CH₂ groups in the cyclohexylene group may be substituted with —CH═CH—, —CF₂O—, or —OCF₂— and one or two or more CH groups in the 1,4-phenylene group may be substituted with a nitrogen atom), Z^{LC61} and Z^{LC62} independently represent a single bond, —CH═CH—, —C≡C—, —CH₂CH₂—, —(CH₂)₄—, —COO—, —OCH₂—, —CH₂O—, —OCF₂— or —CF₂O—, and mⁱⁱⁱ¹ represents 0 to 3 but the compounds represented by the general formulae (LC1) to (LC6) are excluded).

5. The polymerizable compound containing liquid crystal composition according to claim 1, wherein in the general formula (1), Z¹¹ represents -Sp¹²-R¹² and R¹¹ and R¹² independently represent any of the formulae (R-1) to (R-3).

6. The polymerizable compound containing liquid crystal composition according to claim 1, wherein in the general formula (1), m¹¹+m¹³ is 3 or more.

7. The polymerizable compound containing liquid crystal composition according to claim 1, wherein
in the general formula (1), L¹¹ is a single bond, —OCH₂—, —CH₂O—, —CO—, —C₂H₄—, —COO—, —OCO—, —COOC₂H₄—, —OCOC₂H₄—, —C₂H₄OCO—, —C₂H₄COO—, —CH═CH—, —CF₂—, —CF₂O—, —(CH₂)_{z}—C(═O)—O—, —(CH₂)z-O—(C═O)—, —O—(C═O)—(CH₂)z-, —(C═O)—O—(CH₂)z-, —OCF₂—, or —C≡C—,
L¹² is —OCH₂CH₂O—, —COOC₂H₄—, —OCOC₂H₄—, —(CH₂)_{z}—C(═O)—O—, —(CH₂)z-O—(C═O)—, —O—(C═O)—(CH₂)z-, —(C═O)—O—(CH₂)z-, —C₂H₄OCO—, or —C₂H₄COO—, and
z in the formula is an integer of 1 to 4.

8. The polymerizable compound containing liquid crystal composition according to claim 1, wherein in the general formula (1), at least one of L¹¹ and L¹² is at least one kind selected from the group consisting of —(CH₂)_{z}—C(═O)—O—, —(CH₂)z-O—(C═O)—, —O—(C═O)—(CH₂)z-, and —(C═O)—O—(CH₂)z-.

9. The polymerizable compound containing liquid crystal composition according to claim 1, wherein in the general formula (1), m¹² represents 1, 2, or 3, and when m¹² is 1, L¹¹ is a single bond, and when m¹² is 2 or 3, at least one of the plurality of L¹¹ is a single bond.

10. The polymerizable compound containing liquid crystal composition according to claim 1, wherein in the general formula (1), m¹² represents 1, 2, or 3, and when m¹² is 1, M¹² is a 1,4-phenylene group, and when m¹² is 2 or 3, at least M¹² adjacent to M¹¹ through L¹¹ among the plurality of M¹² is a 1,4-phenylene group.

11. The polymerizable compound containing liquid crystal composition according to claim 1, wherein in the general formula (1), m¹² represents 1, 2, or 3 and at least one of M¹² is a 1,4-phenylene group substituted with one or two or more fluorine.

12. The polymerizable compound containing liquid crystal composition according to claim 1 having negative dielectric anisotropy.

13. A liquid crystal display element comprising a liquid crystal layer formed between a pair of substrates, a transparent electrode, and a polarization plate, wherein
the polymerizable compound containing liquid crystal composition according to claim 1 is housed in a space formed between the pair of substrates, and
liquid crystal is aligned by polymerizing the polymerizable compound in the liquid crystal layer.
